(19) United States
(12) Patent Application Publication
(10) Pub. No.: US 2007/0012759 A1
(43) Pub. Date: Jan. 18, 2007

(54) Electronic card tracking system

(76) Inventors: Mark P. Allarea, San Mateo, CA (US); Scott D. Adams, San Mateo, CA (US); Joanne J. Remillard, San Mateo, CA (US)

Correspondence Address: COURTNEY STANIFORD & GREGORY LLP, P.O. BOX 9686, SAN JOSE, CA, 95157, US

(21) Appl. No.: 11/473,951

(22) Filed: Jun. 22, 2006

Related U.S. Application Data
(60) Provisional application No. 60/693,312, filed on Jun. 22, 2005.

(51) Int. Cl. G07F 19/00; G06K 5/00; G07G 1/14; G06Q 40/00

(52) U.S. Cl. 235/379; 235/380; 705/14; 705/39

(57) ABSTRACT

Electronic card tracking systems and methods are described that support electronic scrip programs and transactions. An electronic scrip provider receives transaction data of a transaction between a merchant and a supporter. The transaction data is electronic data of the transaction, and the transaction is a purchase transaction involving use of a card. The merchant is automatically debited by a rebate amount for the transaction. A first portion of the rebate amount debited from the merchant is automatically credited to an organization. A second portion of the rebate amount debited from the merchant is automatically credited to a scrip distributor.

### RELATED APPLICATION

This application claims the benefit of U.S. Patent Application No. 60/693,312, filed Jun. 22, 2005.

### TECHNICAL FIELD

The disclosed embodiments relate to electronic scrip transactions and, more particularly, to settling transactions using an automated electronic scrip.

### BACKGROUND

Typically, scrip is a paper certificate that is sold by organizations to raise funds. In practice, a scrip distributor acquires the scrip from participating merchants and sells the scrip to an organization at an organization discount. In turn, the organization sells the certificates at face value to holders for a profit. The holders then exchange the face value of the scrip for goods or services from the participating merchants. The participating merchants redeem the scrip with the distributor at a deeper, merchant discount, and the distributor also makes a profit. Operationally, the distributor must maintain accounts for its scrip sales to each of the different organizations and for its scrip redemptions by each of the participating merchants. Similarly, the organizations and participating merchants must also maintain accounts on their scrip activity.

Since the scrip is traditionally a hard currency substitute, the scrip sales and scrip redemptions must be recorded according to rules of formal accounting and then settled to the accounts of the scrip provider, also referred to as a scrip distributor, the organizations and the participating merchants. The labor required to manage the various accounts, together with the inherent float time associated with completing a transaction, jeopardize the feasibility of these accounts since the profit margins are small.

Scrip is traditionally a paper certificate that can be used as money to purchase goods or services. In the past, scrip has been used as paper money issued for temporary emergency use, such as in war times. However, more recently, scrip is used somewhat like a coupon or gift certificate and is sold by organizations for the purpose of raising funds. In a typical fund raising process, a scrip provider makes bulk purchases of discounted scrip from any number of participating local and nationwide businesses. The discounted amount may vary, depending on the terms of the deal that the scrip provider is able to negotiate with a particular business. The scrip provider sells the scrip to fund-raising or other organizations at a distribution price equal to the discounted price plus a small handling fee. The organizations then sell the scrip to their members at full value. Thus, the organizations collect the difference between the full value of the scrip and the distribution price.

Scrip is advantageous in fund-raising, because it can be used as a money substitute for goods that a consumer is already going to buy. This is in contrast to other traditional fund raising events that require donations or that require the consumer to purchase items that they do not really need or want, such as cookie sales. The scrip, for example, can be used to purchase practically anything, including groceries, toys, household goods, restaurant meals, and bus, train or airline tickets.

The system for distribution of, and accounting for, conventional scrip is time-consuming and arduous, as the paper certificates are transferred from the participating stores to the providers, the organizations, and finally to the consumers. Scrip is sent from each merchant to the provider, who must manually sort and file the various types of scrip. With the receipt of orders from the numerous organizations, the various merchants' scrip is accumulated for each order and then sent back to the ordering organization. Thus, the conventional scrip system is essentially a manual process.

Further, because it is a paper money substitute, scrip has all of the disadvantages of paper money. Scrip is subject to counterfeiting, because the paper certificates do not have all of the security features of regular U.S. currency, such as special paper. Also, it may be easily mutilated or destroyed, such as by leaving it in a garment pocket that goes through a washing machine. Additionally, consumers may find it difficult to keep track of their scrip, as it comes in many different shapes and sizes.

Additionally, a consumer may be able to use scrip only at the specific business that issued the scrip. This is especially true because of the varying discount rates granted by the different businesses. These discount rates may vary from region to region, or even from store to store. Thus, it is inconvenient for consumers to make sure that they have the proper scrip with them. Consequently, there is a need for automated electronic scrip systems and methods that make use of an electronically controlled system for the distribution and accounting of scrip.

### INCORPORATION BY REFERENCE

Each publication, patent, and/or patent application mentioned in this specification is herein incorporated by reference in its entirety to the same extent as if each individual publication, patent and/or patent application was specifically and individually indicated to be incorporated by reference.

### BRIEF DESCRIPTION OF THE DRAWINGS

FIG. 1 is a block diagram of the ACS that shows information flow among participants and components of the ACS, under an embodiment.

FIG. 2 is a block diagram of the ACS provider, under an embodiment.

FIG. 3 is a flow diagram for electronic scrip transactions, under an embodiment.

FIG. 4 is a transaction flow diagram for ACS transaction processing, under an embodiment.

FIGS. 5 and 6 each show an example of Merchant Invoice Monthly Invoices (Merchant Settlement Invoice), under an embodiment.

FIG. 7 is an example of a Merchant Invoice by Store, under an embodiment.

FIG. 8 is an example of a Merchant Invoice Summary Report, under an embodiment.

FIGS. 9 and 10 each show an example of Merchant Invoice by Supporter Reports, in CSV and PDF file formats respectively, under an embodiment.

FIGS. 11 and 12 each show an example of Merchant Invoice by Group Contribution Reports, in CSV and PDF file formats respectively, under an embodiment.

FIGS. 13 and 14 each show an example of Merchant Invoice Transaction Detail Reports, in CSV and PDF file formats respectively, under an embodiment.

FIG. 15 is an example of a Merchant Transaction Summary Report, under an embodiment.

FIGS. 16 and 17 are example Merchant Reconciliation Reports, under an embodiment.

FIGS. 18 and 19 each show an example Group Statement Summary Report, in CSV and PDF file formats respectively, under an embodiment.

FIGS. 20 and 21 each show an example Group Statement by Merchant Report, in CSV and PDF file formats respectively, under an embodiment.

FIGS. 22 and 23 each show an example Group Statement by Supporter Report, in CSV and PDF file formats respectively, under an embodiment.

FIG. 24 is a Supporter File email, under an embodiment.

FIG. 25 is an ESI Group File email, under an embodiment.

FIGS. 26A and 26B is an example Supporter Statement Data Request, under an embodiment.

FIG. 27 is an example Supporter Statement Transaction Data Request, under an embodiment.

FIGS. 28A and 28B show an example Supporter Statement, under an embodiment.

### DETAILED DESCRIPTION

Electronic card tracking systems and methods are described that support electronic scrip programs and transactions. An electronic scrip provider receives transaction data of a transaction between a merchant and a supporter. The transaction data is electronic data of the transaction, and the transaction is a purchase transaction involving use of a card. The merchant is automatically debited by a rebate amount for the transaction. A first portion of the rebate amount debited from the merchant is automatically credited to an organization. A second portion of the rebate amount debited from the merchant is automatically credited to a scrip distributor.

An electronic card tracking system is described below and referred to herein as the “Affinity Card System” (ACS). The ACS includes one or more electronic scrip programs that function to provide automated electronic scrip systems and methods that make use of an electronically controlled system for the distribution and accounting of scrip, for example, between merchants, organizations (also referred to herein as “groups”), and supporters. An example of the ACS is available from Electronic Scrip, Inc. (“ESI”) of San Mateo, Calif., and this system may be referred to herein as the “ESI Affinity Card System”. A provider of the ACS, like ESI, is referred to herein as an “ACS provider” but is not so limited. The ACS, as a central processing point that brings together supporters, merchants, and organizations, provides organizations a convenient way to help raise funds and automate the settlement process.

The ACS of an embodiment generally allows participating business partners (e.g. retailers) to contribute a percentage of purchases made using loyalty cards, credit card, and debit/automatic teller machine (ATM) card purchases to an organization (e.g., school, church, fundraising organization, non-profit organization, etc.) designated by the supporter. Using the ACS, a supporter registers any one or all of his/her existing loyalty cards, credit cards, and/or debit cards for use in the ACS program. The supporter nominates one or more organizations as a beneficiary of rebates or contributions by participating merchants. The participating merchants will make contributions to the enrolled and nominated organizations based on purchases made by the supporter at that merchant using the registered cards. By using these registered cards at participating merchants, supporters generate donations based on a percentage of purchases as determined by each merchant or service provider. Supporter purchases are tracked and available to the supporter and/or nominated organization via, for example, an online electronic site or web site. For example, periodically, (e.g. every month) the enrolled organizations receive all merchant contributions made on behalf of all supporters. A summarized report listing supporters, merchants, and contributions amounts are available online.

The ACS of an embodiment thus provides fundraising programs that allow participating merchants to contribute a percentage of a supporter's loyalty card, credit card, and debit/ATM card purchases for example to the organization of the supporter's choice. Paper-based fundraising programs have become a proven benefit to organizations like schools and churches, and to all the people involved with these participating organizations. The ACS therefore brings an ease of use to fundraising programs by automating participation in scrip fundraising. Using the ACS, a supporter is not required to pre-purchase paper certificates prior to making a purchase. Also, supporters will not “run out” of paper certificates, since they always have their registered cards with them for purchases. The ACS is also convenient for times when a supporter does not have scrip, last minute shopping, holidays, travel, and business/corporate expenses. Furthermore, the ACS covers a wide range of merchants that organizations may not “stock” in paper. The ACS also relieves merchants of the burden of tracking purchases with paper scrip because the tracking and remittance process is automated.

For convenience, some of the terms used in this document are defined here. However, these definitions must be viewed in the context of the entire document, and these and other terms are defined at least in part by examples given throughout this document. “Merchants” in general are retailers or businesses that buy and sell goods for profit, including dealers, traders, storekeepers and the like. “Supporters” include individuals who desire to support organization through the purchase of scrip. “Organizations” or “groups” include those organizations which raise funds through the sale of scrip; examples include schools, churches, fundraising organizations, and non-profit organizations to name a few. “Electronic transactions” include credit card transactions, smart card transactions, electronic check transactions, electronic currency transactions, electronic funds transfers, and other transactions in which monetary assets are transferred with the aid of a standalone and/or networked computing device or computing system. The transactions contemplated under the invention include at least electronic transactions and cash transactions. “Card” includes at least one or more of a credit card, charge card, prepaid card, smart card, debit card, ATM card, bank card, gift card, and loyalty card (e.g. retailer loyalty card).

In the following description, numerous specific details are introduced to provide a thorough understanding of, and enabling description for, embodiments of the ACS. One skilled in the relevant art, however, will recognize that the ACS can be practiced without one or more of the specific details, or with other components, systems, etc. In other instances, well-known structures or operations are not shown, or are not described in detail, to avoid obscuring aspects of the ACS.

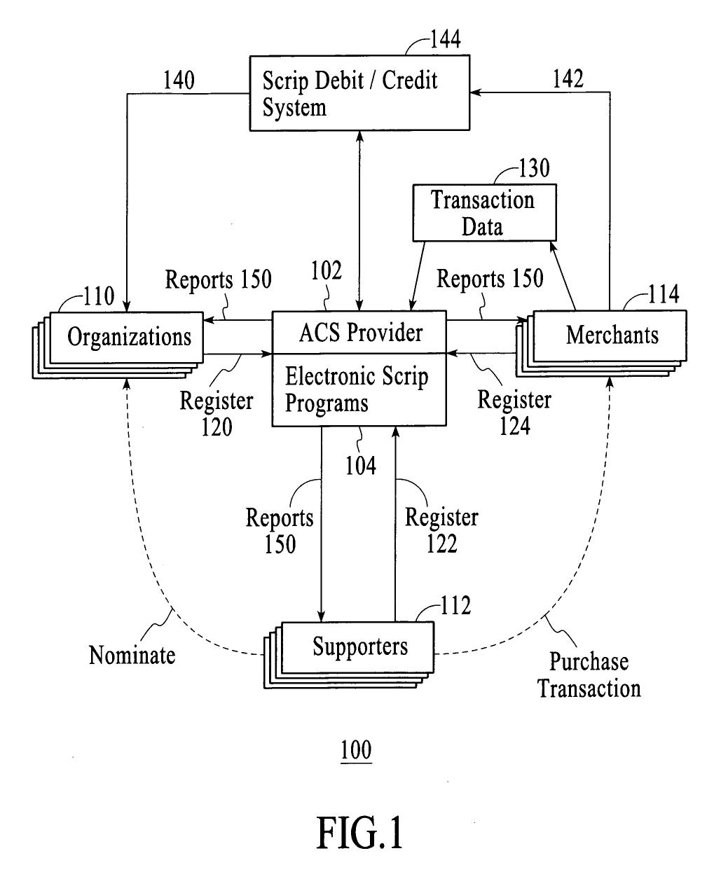

FIG. 1 is a block diagram of the ACS 100 that shows information flow among participants and components of the ACS, under an embodiment. The components of the ACS include the ACS provider 102 and one or more electronic scrip programs 104. Organizations 110 wishing to participate in an electronic scrip program register 120 with the ACS provider 102 and solicit their members or supporters 112 (e.g. individuals) to participate in the program. Supporters 112 may nominate a number of organizations 110 as beneficiary of the scrip rebates. The ACS of an embodiment enables one supporter 112 to nominate up to three (3) beneficiary organizations 110, but the embodiments are not limited to only three beneficiary organizations 110. Supporters 112 can register 122 one or more cards with the ACS provider 102. Participating merchants 114 register 124 with the ACS provider 102 to donate a small percentage of each purchase made by a registered supporter 112 to an organization 110 designated by the supporter 112. The registration 124 of a merchant 114 with the ACS provider 102 takes the form of a contractual agreement, but is not so limited.

The ACS provider of an embodiment periodically receives and processes the transaction data 130 that it receives from a transaction processor. The transaction data 130, also referred to as transaction clearing files 130, includes the data of some or all customer transactions with the merchant to which the transaction data 130 correspond. The transaction processor of an embodiment includes the merchants 114 as well as third-party transaction processors (not shown), for example, banks, vendors, gift card processors, Point of Sale (POS) systems, data warehouses, and switch companies, to name a few.

The ACS provider 102 processes the received transaction data 130 and identifies “qualifying” transactions. A qualifying transaction is a transaction on a registered card that took place at a merchant 114 that is registered with or participating in the ACS. The ACS provider 102 uses the transaction data 130 to manage the process of electronically debiting 142 merchants 114 and crediting 140 the appropriate designated organizations 110. The debiting 142 of merchants 114 and corresponding crediting 140 of designated organizations 110 can be performed by the ACS provider 102 using one or more third-party systems (e.g. the Federal Automated Clearing House system) 144, but is not limited to being performed through a third-party system. The ACS also provides supporters 112 and merchants 114 with easy access to reporting 150 through the Internet and other electronic media.

The ACS provider 102 of an embodiment includes one or more electronic scrip programs 104 as described in detail below. As an example, the ACS provider 102 provides four embodiments of electronic scrip programs 104. In some cases a combination of two or even all four types of electronic scrip programs 104 may be implemented for a merchant 114. The ACS provider 102 works with the merchant 114 to determine which of the electronic scrip programs 104 are appropriate for that merchant 114. The electronic scrip programs 104 of an embodiment include a credit/debit card scrip program, loyalty card scrip program, community card scrip program, and giving card scrip program. The electronic scrip programs 104 described below encompass all types of transactions including one or more of transactions at the point of sale, online transactions via a merchant web site, mail order, and phone order transactions.

The ACS credit/debit card scrip program allows supporters to register one or more credit or debit cards with the ACS provider 102. The ACS credit/debit card scrip program provides a simple and convenient way to participate in an electronic scrip program by registering major credit cards with the ACS provider 102. The credit/debit card scrip program involves the merchant 114, the merchant's credit card transaction processor (e.g. bankcard acquirer) and the ACS provider 102 in a transaction as described below.

At the outset of the program, the merchant 114 sends a letter to their credit card processor authorizing the credit card processor to deliver credit and debit card transaction data to the ACS provider 102. A consumer then makes a purchase at a participating merchant 114 using a credit or debit card that the consumer has registered with the ACS provider 102. The merchant's credit card processor captures the transaction data for all of the credit card transactions of the merchant. On a periodic basis (e.g. daily) the merchant's credit card processor transmits the transaction data to the ACS provider 102 (e.g. data warehouse). The ACS provider 102 scans the transaction data to identify the transactions in which registered credit and debit cards were used for purchases at the merchant. The ACS provider 102 compiles the transaction data and provides tracking and reporting for organizations 110, supporters 112 and merchants 114. The ACS provider 102 distributes the appropriate amount of funds (e.g. donations) to the organizations 110 according to information of the transaction data 130 and the agreement between the merchant 114 and the organization 110.

The ACS loyalty card scrip program uses an existing merchant loyalty card to track supporter purchases. The supporter 112 registers the loyalty card with the ACS provider 102 and then presents the card to the merchant 114 at the time of purchase. The card is read by the merchant's POS/loyalty system during the purchase transaction, for example, at approximately the same time that payment is processed (cash, check, credit card, debit card, etc.) The merchant's POS/loyalty system captures the transaction data 130 which includes information like the date, time, amount and/or location of the transaction, and forwards the transaction data 130 to the ACS provider 102 (e.g. data warehouse). All of the loyalty card transaction records are transmitted directly to the ACS provider 102 on a periodic basis (e.g. daily, weekly, monthly, etc.). The ACS provider 102 receives and compiles the transaction data and provides tracking and reporting for organizations 110, supporters 112 and merchants 114. The ACS provider 102 distributes the appropriate amount of funds (e.g. donations) to the organizations 110 according to information of the transaction data 130 and the agreement between the merchant 114 and the organization 110.

The ACS Community Card scrip program includes use of a Community Card. The Community Card is a non-financial instrument that is functionally similar to a customer loyalty card. The Community Card uses a number sequence that can identify the merchant, store location, SKU, and consumer. The supporter 112 presents the Community Card with each purchase that they make at a participating merchant 1114. Information of the Community Card is read by the POS system at the merchant 114 at approximately the same time that payment is processed (cash, check, credit card, debit card, etc.). The merchant's POS system captures the transaction data which, in an embodiment, includes the date, time, amount, and location of the transaction. The POS system subsequently forwards the captured transaction data 130 to the ACS provider 102 (e.g. data warehouse). In an embodiment, all Community Card transaction records are transmitted directly to the ACS provider 102 on a periodic basis (e.g. daily, weekly, monthly, etc.). The ACS provider 102 compiles the transaction data and provides tracking and reporting for organizations, supporters and merchants. The ACS provider 102 distributes the appropriate amount of funds (e.g. donations) to the organizations 110 according to information of the transaction data 130 and the agreement between the merchant 114 and the organization 110.

The ACS Giving Card scrip program includes use of a Giving Card. The Giving Card works in a manner similar to that of a gift card. The supporter 112 purchases the Giving Card in preset denominations (e.g. $5, $10, $25, etc.), or designates that the card be activated with an amount of his/her choice. The supporter 112 can purchase the Giving Card from a Giving Card provider or other gift card provider which, in an embodiment, includes merchants 114 or organizations 110 like the beneficiary organization that participate in the ACS. The Giving Card is registered to the purchasing supporter 112 and activated through the merchant's gift card provider. The supporter 112 registers with the ACS provider 102 at the time the Giving Card is purchased. Supporters 112 may “recharge” or place additional value on their Giving Cards as often as desired via add-value transactions.

The POS of a Giving Card provider captures transaction data 130 of a Giving Card sale or add-value transaction. The transaction data 130 of an embodiment includes the date, time, amount, and location of the Giving Card sale or add-value transaction but is not so limited. Giving Card sale and add-value transactions are generally processed through the same system used by the merchant 114 for the regular gift card program, but the Giving Card transactions are tracked and reported on as a separate group of cards from the other gift cards. On a periodic basis (e.g. daily, weekly, monthly, etc.) the Giving Card provider transmits a file that includes all of the Giving Card activation and add-value transactions to the ACS provider 102. The ACS provider 102 compiles the transaction data and provides tracking and reporting for organizations 110, supporters 112 and merchants 114. The ACS provider 102 distributes the appropriate amount of funds (e.g. donations) to the organizations 110 according to information of the transaction data and the agreement between the merchant 110 and the organization 114.

The ACS of an embodiment transmits only data of card activation and add-value transactions to the ACS provider 102 because the donations to beneficiary organizations 110 are calculated at the time a Giving Card is purchased or money is added to the Giving Card, but the embodiment is not so limited. Alternatively, purchase transactions of goods and/or services that involve use of a Giving Card can be handled as described above with reference to the other ACS electronic scrip programs.

As an example of an alternative embodiment, when using the Giving Card during a purchase transaction, the transaction system of the Giving Card provider captures the data of all Giving Card transactions. The supporter 112 may use the Giving Card to pay for the total amount of a purchase or it can be used in combination with one or more other payment methods or types. The merchant's POS system captures the transaction data which, in an embodiment, includes the date, time, amount, and location of the purchase. The POS system subsequently forwards the captured transaction data to the ACS provider 102 (e.g. data warehouse). In an embodiment, all Giving Card transaction records are transmitted directly to the ACS provider 102 on a periodic basis (e.g. daily, weekly, monthly, etc.). The ACS provider 102 compiles the transaction data and provides tracking and reporting for organizations 110, supporters 112 and merchants 114. The ACS provider 102 distributes the appropriate amount of funds (e.g. donations) to the organizations 110 according to information of the transaction data and the agreement between the merchant 110 and the organization 114.

The ACS provider 102 of an embodiment includes numerous components appropriate to a processor-based electronic transaction system. Generally, the components of the ACS provider 102 include one or more of processors, memory or memory devices, input/output devices, and network couplings or connections to name a few. Although a variety of different computer systems can be used as the ACS provider 102 and/or coupled to the ACS provider 102, the computer system of the ACS provider 102 generally includes a central processor unit (CPU) or central processor for processing information and instructions.

The ACS provider components, systems, or subsystems as they may alternatively be called, can further include one or more of an address/data bus coupled to the CPU for communicating information, volatile memory (random access memory (RAM) for example) coupled to the bus for storing information and instructions for the CPU, and non-volatile memory (read-only memory (ROM) for example) coupled to the bus for storing static information and instructions for the CPU. The ACS provider 102 may also include one or more optional storage devices coupled to the bus for storing information and instructions. The storage devices or data storage devices can include one or more removable magnetic or optical storage media which are computer-readable memories. Some combination of the volatile memory, non-volatile memory, and/or storage device include or store data structures describing components or processes of the ACS described above, but the ACS is not limited to storage in these devices.

The ACS provider 102 may also include at least one optional display device coupled to the bus for displaying information to the users of the computer system. The ACS provider 102 of an embodiment may also include one or more optional input devices coupled to the bus for communicating information and command selections to the CPU. Additionally, the ACS provider 102 may include an optional cursor control or directing device coupled to the bus for communicating user input information and command selections to the CPU. The ACS provider 102 may also include one or more optional signal transfer devices (transmitter, receiver, modem, etc. for example) coupled to the bus for interfacing with other computer systems.

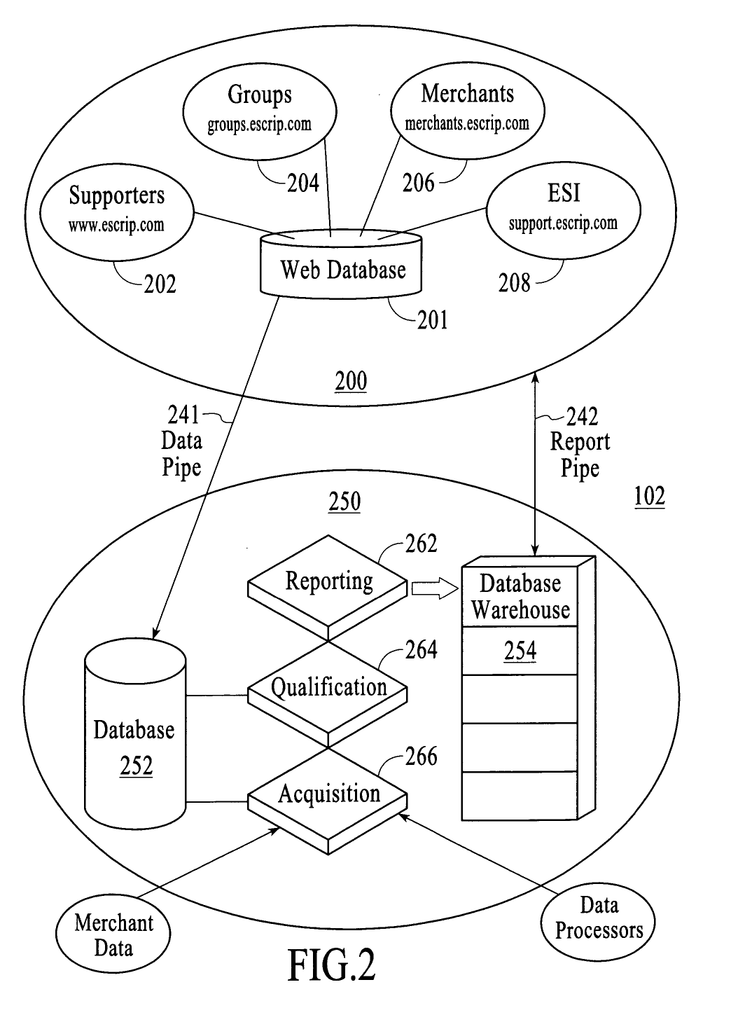

FIG. 2 is a block diagram of the ACS provider 102, under an embodiment. The ACS provider 102 is configured to comprise numerous logical components, systems or parts that include a front-end system 200 and a backend system 250. The front-end system 200 and backend system 250, each of which can include multiple components or subsystems, are described in detail below.

The front-end system 200 of an embodiment includes a database 201 along with user interfaces and applications for setup and maintenance of supporters 202 (e.g. www.escrip.com), organizations or groups 204 (e.g. groups.escrip.com), merchants 206 (e.g. merchants.escrip.com), and support and data entry 208 (e.g. support.escrip.com), together with third-party data imports and exports used to maintain the system. The front-end system 200 allows the ACS provider 102 to directly maintain a database 201 of merchants, organizations, and participating supporters. The front-end system 200 further allows the ACS provider 102 to provide a variety of reports from the transaction database. A detailed description of reporting and data windows is provided below.

The server configuration of the front-end system 200 of an embodiment includes one or more servers (not shown) configured to perform a variety of functions across one or more environments (e.g. development, testing, staging, production, etc.). For example, the front-end system 200 can include one or more of a web presentation server (e.g. proxy to application server for dynamic pages), web application server (e.g. provides dynamic pages and database access), database server, image server, file server (e.g. storage for incoming and outgoing files), mail server, and utility server. The servers of the front-end system 200 can be co-located or distributed in location, and couple to other components of the ACS as well as the merchants, organizations, and supporters via one or more network couplings or connections. The servers of the front-end system 200 host one or more applications as appropriate to the functions and transactions of the ACS. The front-end system 200 implements electronic security measures as appropriate to the transactions of the ACS. The front-end system 200 exchanges data with the backend system 250 through a server online gateway, for example, or through data import/export functions, but is not so limited.

The backend system 250 is configured to allow the ACS provider 102 to acquire, qualify, and report merchant transactions. The backend system 250 may be managed by a company that receives bankcard or other transaction data from multiple bankcard acquirers on a bulk file or merchant-by-merchant basis, but is not so limited. The backend system 250 of an embodiment includes a database 252 coupled to a data warehouse 254. The backend system 250 includes one or more applications for acquisition 266, qualification 264, and reporting 262 of data. As one example, the database 252 receives data from components of the front-end system 200 via a data pipe or channel 241, and the data warehouse 254 exchanges report data or information with components of the front-end system 200 via at least one report pipe or channel 242. The data pipe 241 and report pipe 242 can comprise a network but are not so limited.

In providing registration functionality, the ACS provider 102 uses the front-end system 200 to maintain a registered supporter table within the front-end database 201. A user interface of the front-end system 200 is configured to allow the ACS provider 102 to enter a consumer's contact information and register a number of cards (e.g. at least three (3) cards) to that consumer. Card types that may be registered include Community Cards, Giving Cards, all major credit and debit cards, and merchant loyalty cards as described above. The front-end system 200 is also configured to allow the user to change or delete records in the registered supporter table.

The ACS provider 102 enables merchant accounting and, as such, is configured to use the front-end system 200 to add, change and/or delete records in the participating merchant table. The information included in this table is used to determine the dollar amount that each merchant owes at settlement time based upon the qualified transaction identified, but is not so limited. The determined dollar amount is calculated based on the percentage of sales that the merchant has agreed to contribute to nonprofit organizations in the ACS provider plan as described above.

The ACS provider 102 is configured to provide organization accounting by using the front-end system 200 to add, change or delete records in the group table. This table is used to track how much each organization is entitled to as well as the processing fees that the ACS provider 102 will charge the organization. The ACS provider's fees are based for example on a percentage of the total funds raised for the organization. This table is also used directly or indirectly to track one or more of registered supporter activity for an organization and additional information on the salesperson or sales team that signed the merchant. Regarding the registered supporter activity for this organization or sub-group, reports that are based on this information allow the organization to see the total amount of contributions for each supporter associated with their group. In private schools, for example, this information may be used for tuition credits.

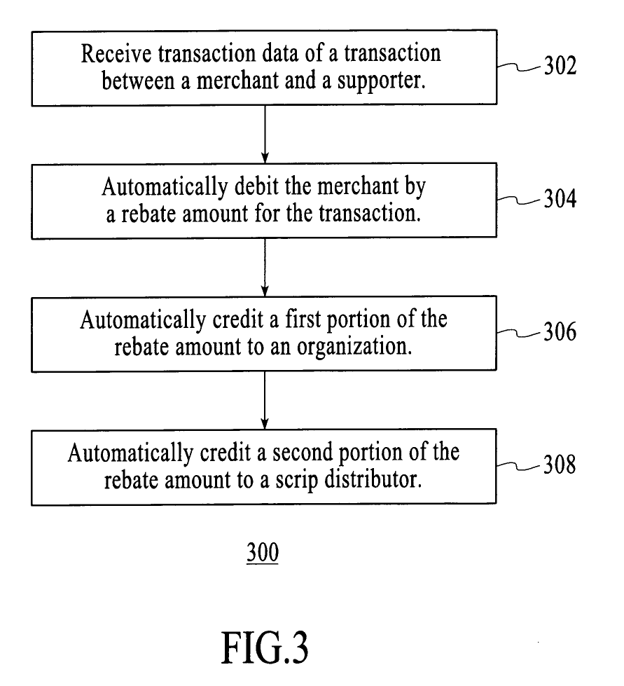

The ACS provider 102 processes card transactions to provide automated electronic scrip systems and methods for the distribution and accounting of scrip, for example, between merchants, organizations, and supporters. FIG. 3 is a flow diagram 300 for electronic scrip transactions, under an embodiment. An electronic scrip provider, like the ACS for example, receives transaction data 302 of a transaction between a merchant and a supporter. The transaction data is electronic data of the transaction, and the transaction is a purchase transaction involving the use of a card. The merchant is automatically debited 304 by a rebate amount for the transaction. A first portion of the rebate amount debited from the merchant is automatically credited 306 to an organization. A second portion of the rebate amount debited from the merchant is automatically credited 308 to a scrip distributor.

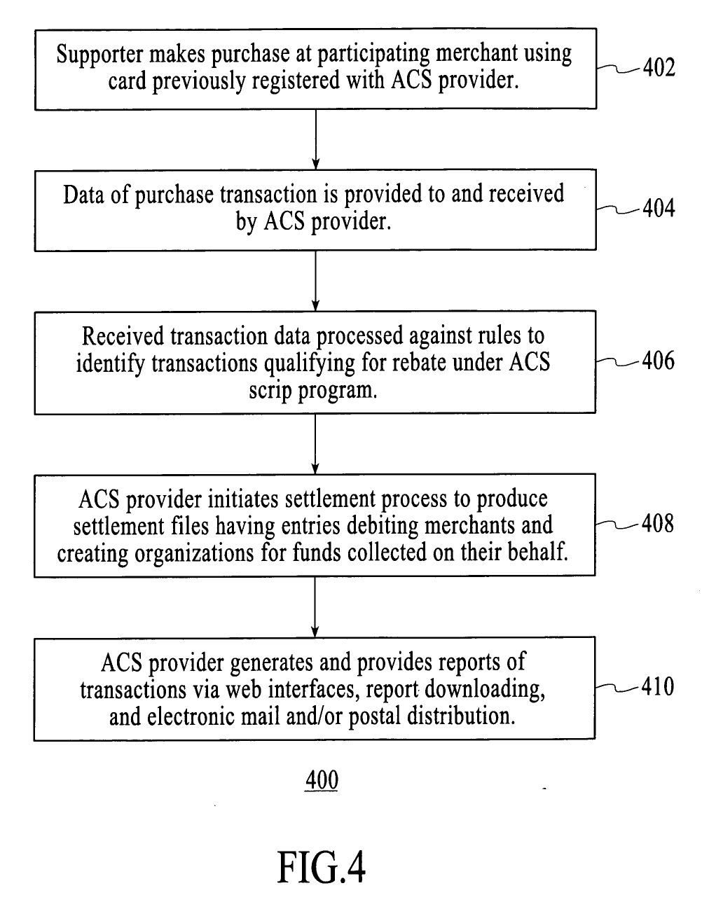

As a more specific example, FIG. 4 is a transaction flow diagram 400 for ACS transaction processing, under an embodiment. An affinity supporter makes a purchase 402 at a participating merchant using a card that was previously registered with the ACS provider. Subsequent to one or more purchase transactions involving a card, the data of the purchase transaction is provided to and received 404 by the ACS provider. The transaction data used by the ACS provider is received in files from a variety of sources. Once the ACS provider contracts with a merchant, this merchant arranges to supply transaction data directly or to ship transaction data indirectly through a third party. In each case the transaction data includes one or more of the merchant identification, transaction date, card number, purchase amount, cash back amount (if applicable), etc.

The received transaction data is processed 406 against a set of business rules in order to identify the transactions that qualify for rebate under the rules of the ACS scrip program, as determined by the specific agreement in place with each individual Merchant. The qualifications passed in transaction data processing are logged in the database to allow query runs and reporting. The reports generated are for merchants, groups, supporters, and management on the level of Monthly Invoices, Transaction Detail, ACH distribution, Merchant Reconciliation, Unusual Transactions, Merchant Capping, and Enrolled and Pre-enrolled Groups as described herein.

The ACS provider of an embodiment initiates the settlement process 408 to produce Automated Clearing House (ACH) settlement files which include entries debiting the merchants at the chain level and crediting organizations for funds collected on their behalf. The ACS provider processing fee may be debited from the credit to organizations for funds collected on behalf of the organization but the embodiment is not so limited. The files are in the National Automated Clearing House Association (NACHA) 1997 ACH Operating Rules.

The ACS provider generates and provides reports 410 of the transactions via one or more web interfaces, downloading of the reports, and or provision of the reports via electronic mail or postal distribution. The ACS provider provides reporting to one or more of merchants, supporters and groups. Reporting in an embodiment is based on a cash-based accounting method showing collected funds, but is not so limited. The ACS provider of an embodiment also uses the front-end system for internal reporting, sales tracking and/or customer support to name a few.

Referring to FIGS. 1-4, the operations of the processes are under control of at least one processor, but are not so limited. Aspects of the ACS, described herein, are described in terms of processes executed on a computer system or other processing system. These processes are implemented as program code stored in machine-readable or computer-readable memory areas or devices of a computer system and are executed by the processor of the computer system. Those skilled in the relevant art can create source code, microcode, program logic arrays or otherwise implement the invention based on these flow diagrams and the detailed description provided herein. The algorithm or routine operating according to these flow diagrams is stored in non-volatile memory that forms part of the associated processors, in the associated memory areas, in removable media, such as disks, or hardwired or preprogrammed in chips, such as electronically erasable programmable ROM (EEPROM) semiconductor chips, or in any combination of these components, but is not so limited.

The front-end 200 and backend 250 systems of the ACS provider 102 are coordinated across a number of data elements and reports, and the system interface for the front-end system 200 provides a secure, serviceable and extensible interface. The interface of an embodiment supports report requests and maintenance of ACS currency, each of which are described below.

Users of web applications include ACS provider staff, merchants, organization or group coordinators and supporters. The interface of the front-end system 200 supports and/or includes a variety of reports as described in detail below. Some reports can be scheduled for periodic output by the backend system and make use of an asynchronous download by the user; examples of these reports include Group ACH, Merchant ACH, Merchant Reconciliation, and Pre-Enrolled and Fully Enrolled reports to name a few. Other reports are delivered in real time in response to a request from the front-end system; examples of these reports include the merchant, group and supporter statements. Reporting examples follow.

In one example, a supporter requests (e.g. Hypertext Markup Language (HTML)) his/her Supporter Statement via the web and the user interface of the front-end system 200. The web application server passes a request to the backend system 250 including the supporter identification, report name, return type and report date. The backend system 250 responds to the request returning the required statement data to the calling server. The web application server formats the statement data and returns a HTML-encoded statement to the supporter.

As another example, a group coordinator requests a Group Statement Summary via the web and the user interface of the front-end system 200. The web application server passes a request to the backend system 250 including the group identification, report name, return type, starting month and ending month. The backend system 250 responds to the request returning the appropriate statement data to the calling server. The web application server formats the statement data and returns a HTML-encoded statement to the group. In contrast, if the user requests a report or summary in a Certified Server Validation (CSV) file type then the backend system returns the CSV file type.

In yet another example, an employee requests the Merchant Transaction Summary via the web and the user interface of the front-end system 200. The web application server passes a request to the backend system 250 including the merchant ID, report name, starting date and ending date. Additionally, this report may include a flag indicating that all merchants need to be included as opposed to a singular merchant. The backend system 250 responds to the request returning the appropriate statement data to the calling server. The web application server formats the data and returns a HTML-encoded report to the user.

The ACS of an embodiment is configured so that calling parameters will be passed from the front-end system 200 to the backend system 250 using some form of Hypertext Transfer Protocol (HTTP) transmission (e.g. Uniform Resource Locator (URL) encoding, in HTTP headers as name value pairs, in HTTP headers as an Extensible Markup Language (XML) construct, etc.). An HTTP response to the application server including structured data in the form of XML is used when the client is requesting HTML. The transformation from XML into HTML or CSV is handled in the front-end system 200 of an embodiment. Additionally, a return of native Portable Document Format (PDF) files and Microsoft Excel files is used for some reports where the return file type is either implicitly defined by the report type parameter or more explicitly sent by the calling application as an argument. The entire conversation is maintained over a secure channel with network plus application security but is not so limited.

The ACS interface (e.g. web interface) of the front-end system 200 is the primary interface for ACS provider employees and customers. Master files maintained on the web database are propagated on regular intervals to the backend system 250 for maintaining system currency. Of paramount interest are the merchant, group, supporter and card master files as well as supporting files (e.g. Channel Master Assignment).

The system interface includes export formats for the front-end and import routines for each of the requisite files on the backend system 250. Validation of the file structures and contents by the backend system 250 are used. The backend 250 and front-end 200 maintain system currency though a series of communication protocols including a transmission report, error log and daily totals from the backend to the front-end in response to an update. Transmissions are made in a secure channel but are not so limited.

The backend system 250 of the ACS provider acquires data of merchant transactions as described above. The acquisition of transaction data includes direct acquisition and indirect acquisition, as described in detail below.

Direct acquisition includes transactions for which the merchant agrees to provide data directly to the ACS provider so that the transaction data files come directly from the merchant. The direct acquisition includes acquisition of transaction data matched with card extract data, transaction data matched without card extract data, and unmatched transaction data.

Direct acquisition of transaction data matched with card extract data requires the ACS provider to transfer supporter registration information to the merchant. To facilitate the identification of each supporter's transactions in the merchants POS database, at month end or at some other interval, the ACS provider sends a card extract file to the merchant. The card extract file includes supporter data corresponding to the merchant's registered loyalty cards. The merchant uses data of the card extract file to match transaction data to individual supporters, thereby allowing the merchant to provide all transaction data matched or associated with the cards of the card extract file.

Direct acquisition of transaction data matched without card extract data requires the merchant to identify transactions at the time of the purchase transaction. In these cases the merchant is able to give the ACS provider a file of all transactions that were identified at the POS. In contrast the provision of the card extract file by the ACS provider, this does not require the ACS provider to send a card extract file to the merchant, and all transaction data received is data of ACS program transactions.

Direct acquisition of unmatched data has the merchant providing a raw transaction file of all transactions that occurred with the merchant, where the transactions involved use of cards designated for earning rebates under the ACS program, within the period.

Using indirect acquisition of data, the merchant agrees to have their credit card processor provide the ACS provider a copy of the merchant's credit and debit card transaction files. The merchant credit and debit card transaction files are generally in the form of a copy of the settlement file, but are not so limited.

As an exception under the indirect acquisition of data, Manual Adjustments are data files originated by the ACS provider. The Manual Adjustment files contain transaction data for multiple merchants and supporters. The included transactions are manual entries for transactions that did not appear in the transaction data file received from the source. For example, a supporter may have conducted a transaction on a card that was incorrectly entered at registration and therefore not picked up in the data cycle. A correction is therefore made on the registration system and the transaction is entered as a manual adjustment rather than through the re-processing of the original data file from the processor. The Manual Adjustment File of an embodiment is generated periodically (e.g. once per month) and is in text format.

The ACS provider of an embodiment performs regular review (e.g. daily) of scheduled and received data files to ensure that all data expected has in fact been delivered and is in a useable state. This allows for identification, reacquisition, and/or regeneration of any missing and/or corrupt data in a timely manner, thus assuring an efficient processing cycle.

The backend system of the ACS provider qualifies data of merchant transactions as described above. The qualification of transaction data includes balancing merchant to supporter to group, parsing and qualifying transaction data using qualification rules, processing transactions and analyzing rejected transactions, ad-hoc processing of qualification exceptions, creating or generating a table of all qualified transactions, verifying status of merchant acquisition and qualification before reporting, and establishing a period-end process, as described in detail below.

Qualification of an embodiment includes balancing merchant to supporter to group. Accordingly, the ACS provider places the three principal constituents, merchants, groups and supporters, in a state of balance as a result of the period-end financial balancing process (e.g. month-end process). The balancing of an embodiment ensures that aggregate merchant invoices and all supporting reports equal the funds distributed to groups plus the associated fees.

Qualification of an embodiment includes parsing and qualifying transaction data using one or more qualification rules. The qualification rules include one or more of the following rules: the net transaction amount should not be zero; the transaction was not a previously processed transaction from that merchant; the merchant must be enrolled on or before the settlement date of the transaction; the settlement date must not be within a merchant-specified period exclude from rebate; the card used in the transaction is registered and active; the supporter is enrolled and active; the supporter is enrolled on or before the transaction settlement date; the card type used in the transaction is accepted for the merchant; and, at least one supported group is not a merchant-specified excluded group from rebate. The transactions are processed and rejected transactions are analyzed with error codes based on the qualification rules.

The qualification includes ad-hoc processing of exceptions to the standard qualification, and generation of a table of all qualified transactions. The ACS provider also verifies a status of the merchant acquisition and qualification before executing any reporting of transaction data.

The qualification of an embodiment includes an end-of-period process that is executed at periodic intervals (e.g. month-end) to handle one of more of the following: base rebates, ACS provider fees, volume rebates, cap analysis, cap reduction, reconciliation, exclude groups, group allocation, group fees, merchant invoices, supporter allocation, merchant ACH, and group ACH. Each of these end-of period items is described below.

The base rebate is the contracted rebate percentage calculated for all transactions regardless of volume thresholds. The rate is specific for each merchant.

The ACS provider fee, as with the base rebate, is calculated at the transaction level. The fee amount of the ACS provider fee may be calculated as either a percentage of the sale amount or as a percentage of the base rebate.

Volume rebates are earned by supporters to reward them for spending higher amounts at a participating merchant. The volume tier calculations are computed for a merchant independent of other merchants to allow the capping analysis described below. The volume rebate is calculated based on the aggregate spent per supporter for the month. The ACS provider supports a finite tier and a retroactive tier volume rebate structure.

Under the finite tier volume rebate structure, the volume rebate is calculated at a different percentage for each spending level. For example, an amount spent during a period (e.g. month) at a merchant of approximately $0 to $100 earns a two percent (2%) rebate. If the same supporter spends between $101 and $300, he/she may earn an additional one percent (1%) on this amount, with additional volume rebates earned on even higher tiers.

Using the retroactive tier volume rebate structure, the volume rebate is calculated based on the aggregate spent during the period (e.g. month), but is calculated back to the first dollar spent. Using the finite tier example, a supporter under the retroactive tier volume rebate would receive the additional one percent (1%) volume rebate on all purchases from $0 to $300 should he/she surpass the first $100 tier.

The cap analysis of an embodiment allows a merchant partner to control costs of the program by setting a monthly or annual budget. In some cases budget caps are set by region. If, after the volume rebates are calculated, the total cost (e.g. the sum of base rebate, volume rebate, and fee) exceeds the budgeted amount, a reduction factor is established that will bring the total cost to the budget target.

When the ACS provider includes cap reduction processing, a reduction factor is established as described above with reference to the cap analysis. Once the reduction factor is established, all qualified transactions are re-processed using this factor to lower the base rebate, volume rebate, and ACS Provider fee by the same percentage.

For certain merchants, a reconciliation report is created to identify total transactions received from data source (sales and transaction count), total transactions qualified, and total transactions disqualified with the reasons for disqualification. This reconciliation report is used by merchant partners as an audit trail and also to identify any disqualification trends, such as a jump in the disqualification percentage for a particular reason in a given month.

In certain cases, merchant partners have the ability to exclude particular groups that do not fit the profile for their loyalty program. In these cases, the group will continue to earn contributions from the other merchant partners on the program. If a supporter has more than one group designated for receipt of his contribution, the non-excluded group(s) will receive the full contribution.

The total contributions earned from transactions are allocated to groups based on their status as pre-enrolled or fully-enrolled groups. Pre-enrolled groups are groups that are not yet activated on the ACS program, but that have been designated by a supporter(s) as the recipient of contributions earned. Fully-enrolled groups are enrolled groups. If a supporter has only pre-enrolled groups selected as recipients of his/her contribution, the rebates will accrue until such time as the group becomes active. If the supporter has one pre-enrolled group and one fully-enrolled group selected, the entire rebate earned would be allocated to the fully-enrolled group. Alternatively, if the supporter had one pre-enrolled group and two fully-enrolled groups selected the rebate would be split with half of the rebate going to each of the fully-enrolled groups. Merchants are not invoiced for pre-enrolled contributions until the pre-enrolled group converts to fully-enrolled status.

A service fee is calculated on the amount earned by each fully-enrolled group, and this service fee is referred to as a group fee. The service fee is generally set across all merchants, but the program has the flexibility to alter this fee at the merchant level and the group level.

The group statement data is calculated to divide or allocate the total contributions earned among all eligible groups. Earned rebates are split between any number of groups depending on the number of groups selected by the supporter.

The merchant invoice is created, reflecting all ACS qualified sales for the period. Totals are displayed to the detail specified by the merchant partner and can be to the individual MID or store level. Adjustments are displayed to reflect one or more of Pre-Enrolled Group Sales that have been accrued but not billed, and additional billings for groups that had Pre-enrolled sales from prior periods and have become active in the current period.

The individual supporter statement data is calculated and reported on a supporter allocation statement. The supporter allocation statement includes all supporter activity by merchant for the current period as well as the current and year-to-date contributions earned by merchant.

A standard merchant ACH file is generated to debit all merchants remitting their contributions electronically. Upon approval, the merchant ACH file is transmitted to the bank for processing.

A standard ACH file is generated to credit all GC groups that have a contribution amount greater than zero. Upon review/approval by management, the file is transmitted to the bank for processing. While most groups receive their contributions via ACH, in rare instances this is not possible. Group contributions that have to be paid by an alternate method, typically check, are identified and a No ACH report is generated to manage these payments.

The ACS produces or generates a variety of reports that are used to track the flow of funds through the system, monitor card usage produce exception reports to identify possible problems and provide account information to supporters, groups and merchants. The amount of information provided in each of the reports is based primarily on the level of the report within the “Card Registration Hierarchy” or the “Transaction Acquiring Hierarchy”. Reports at lower levels provide more detailed information, while reports at higher levels summarize transaction data. The reporting hierarchy clarifies the purpose of each report.

The reports of an embodiment include Merchant Reports, Group ACH and Merchant ACH reports, Merchant Reconciliation Reports, Pre-enrolled and Fully-enrolled Group Reports, Unusual Transaction Reports, Cap Analysis Reports, Group Statements (e.g., web-based), and Supporter Statements, but are not limited to these reports. Embodiments of the ACS can provide numerous other reports that include various types and combinations of data as appropriate to one or more of the transactions, cards, supporters, merchants, and/or organizations. The reports of an embodiment are described in more detail below.

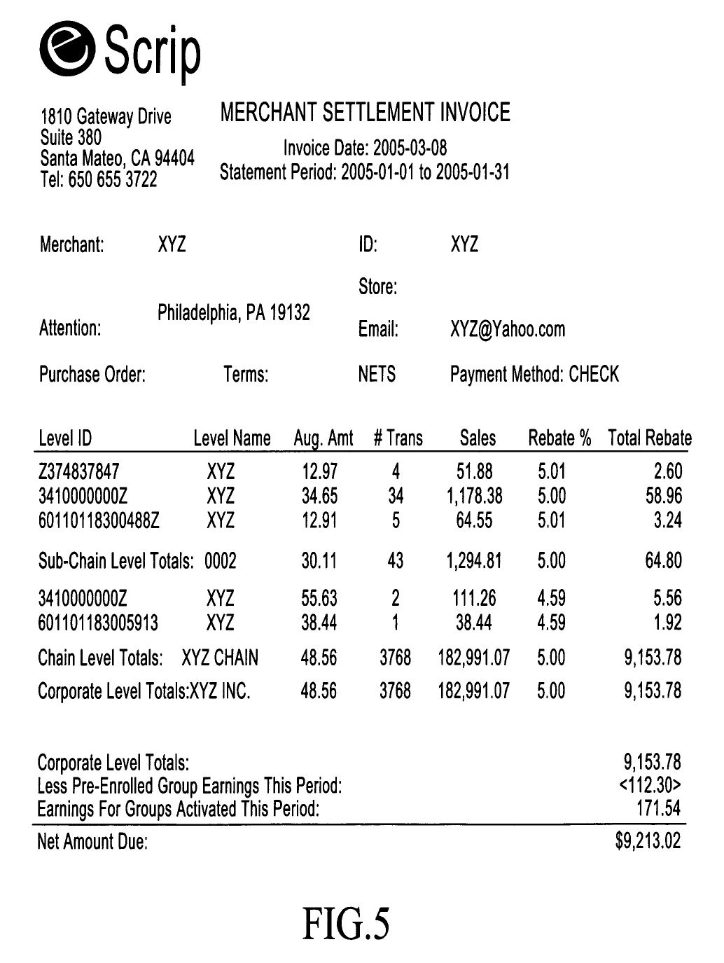

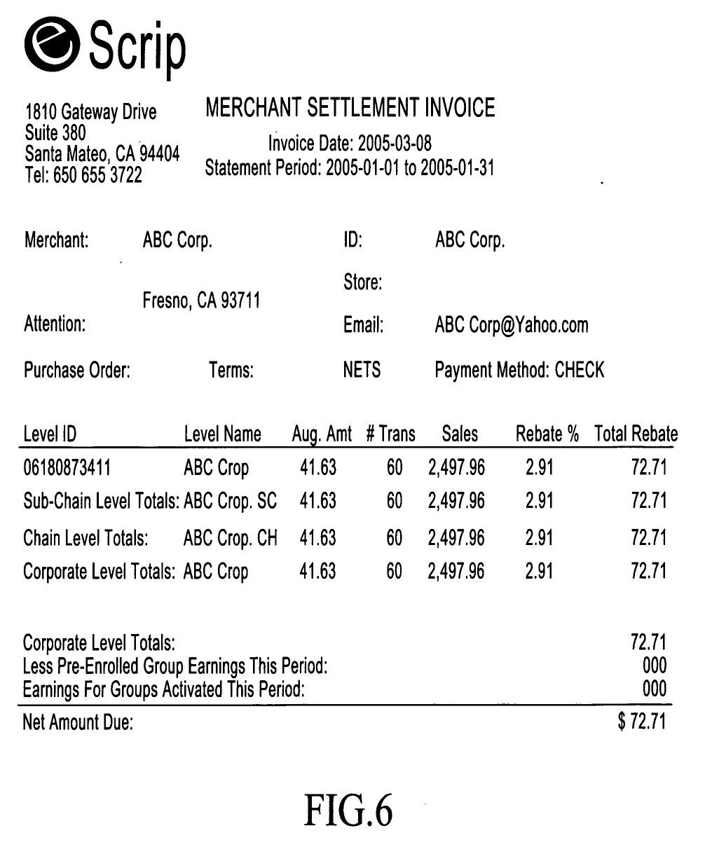

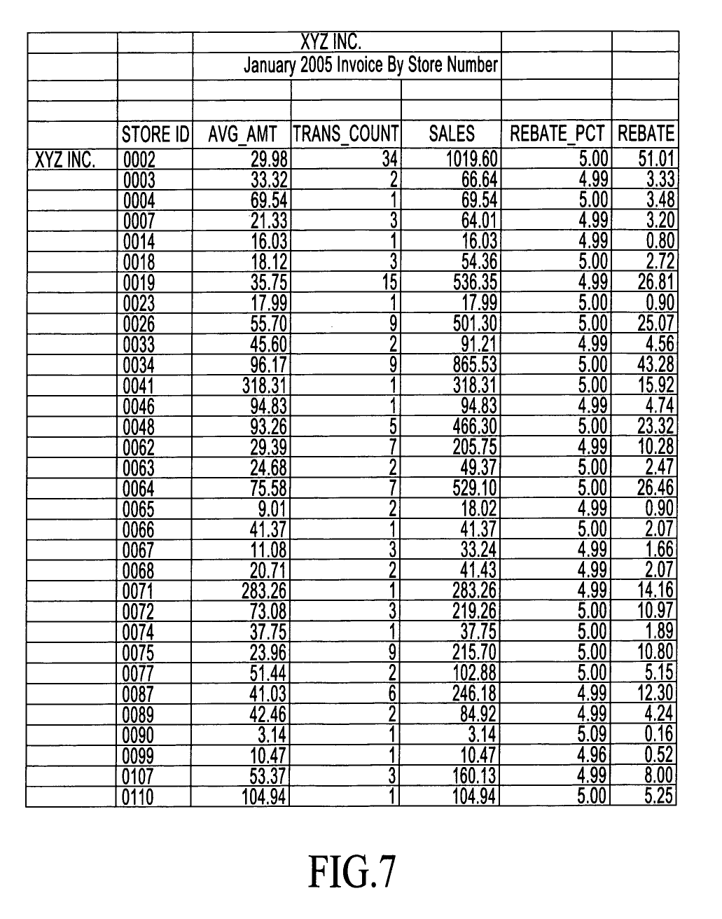

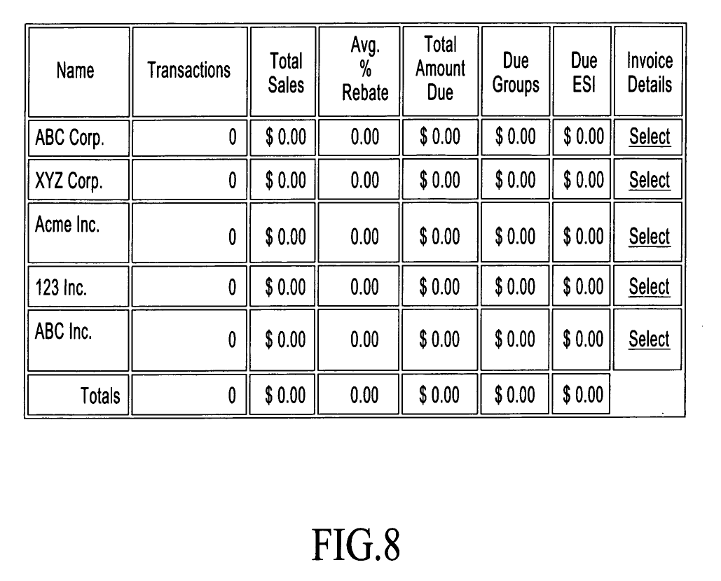

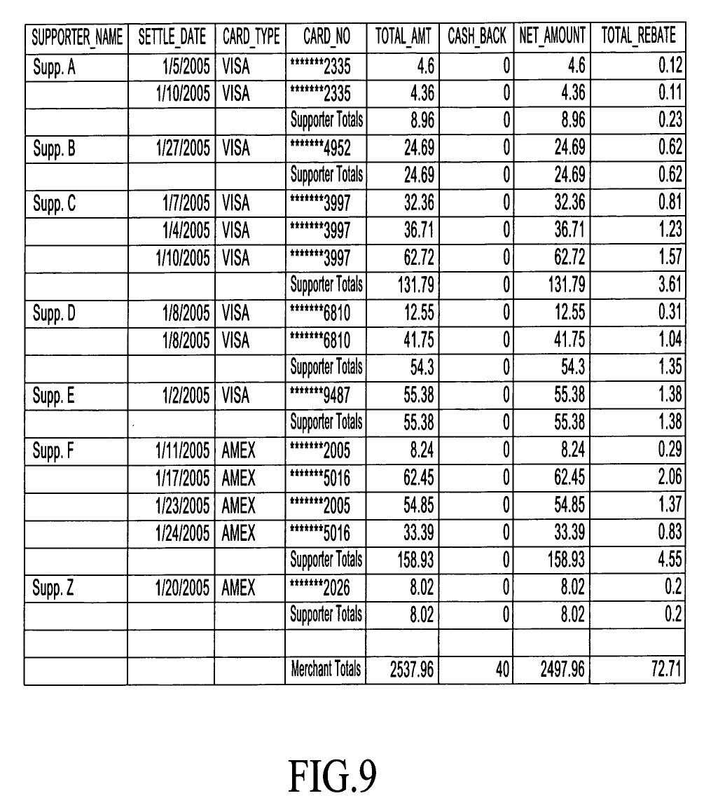

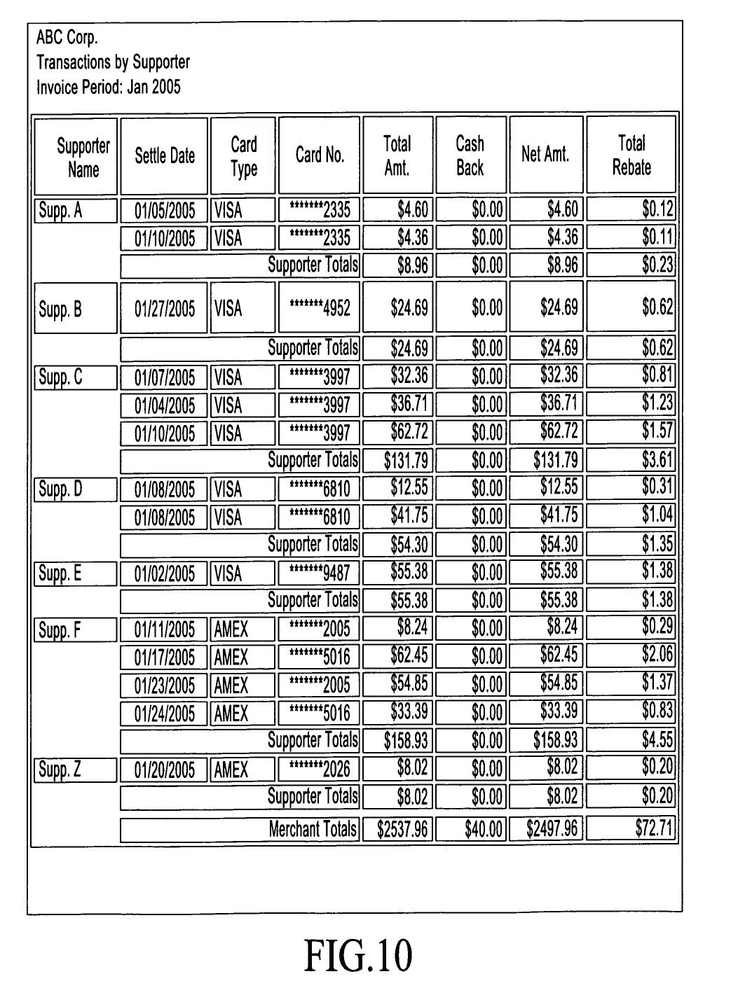

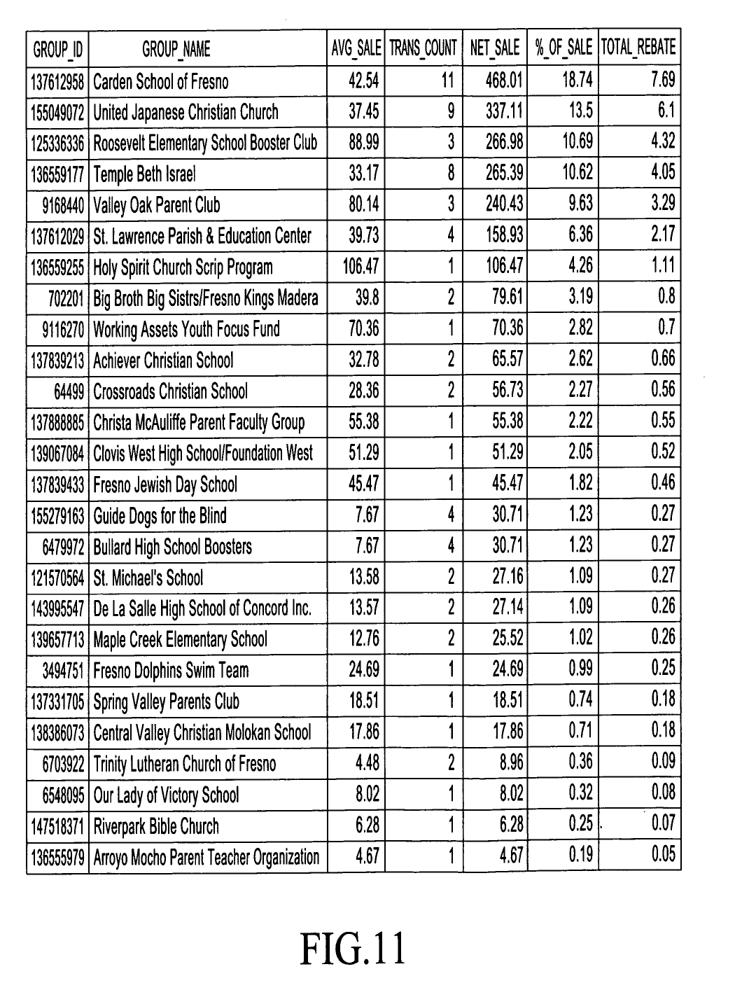

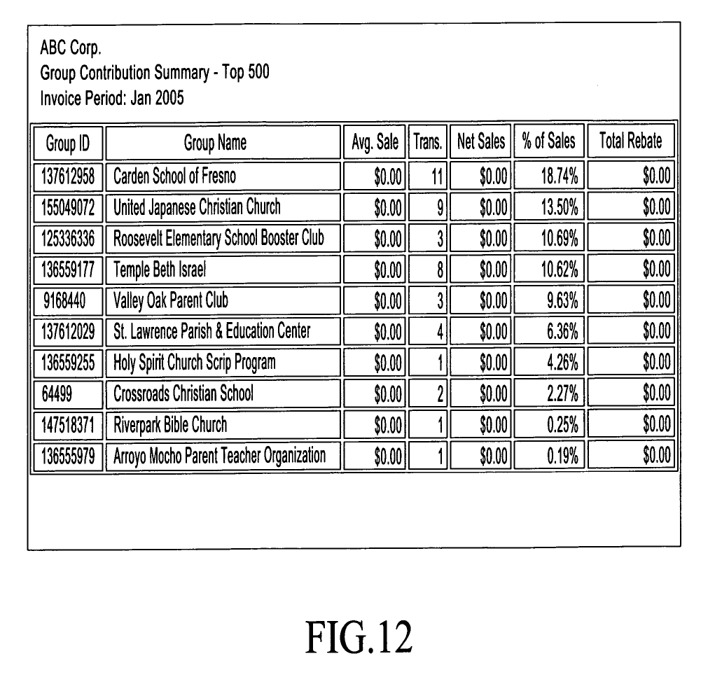

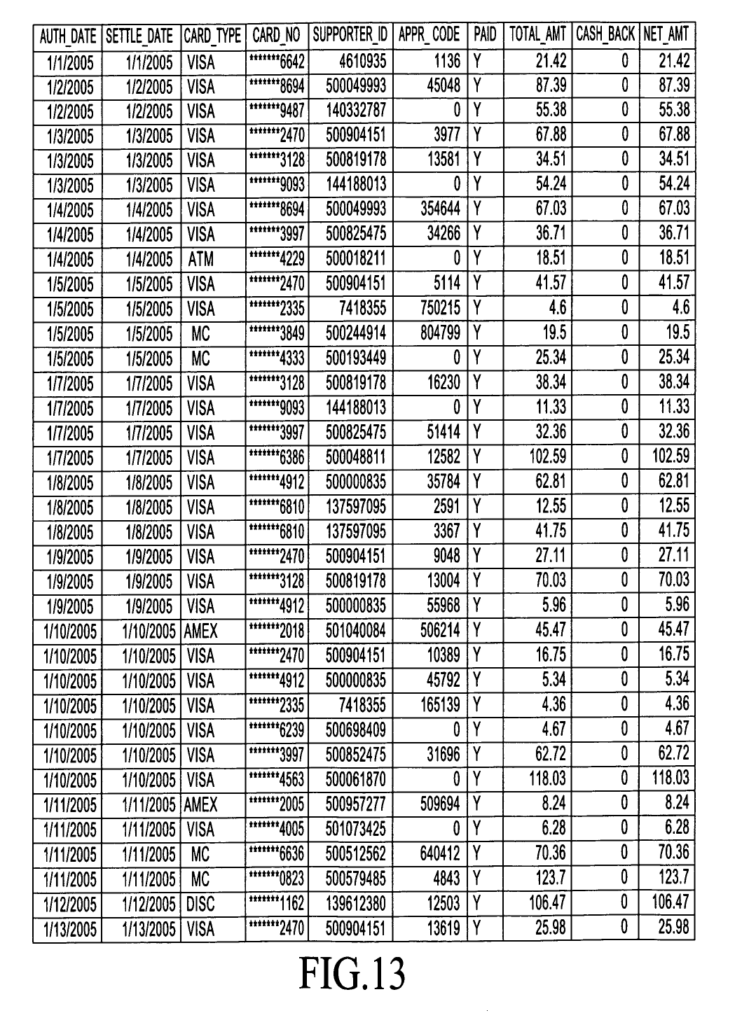

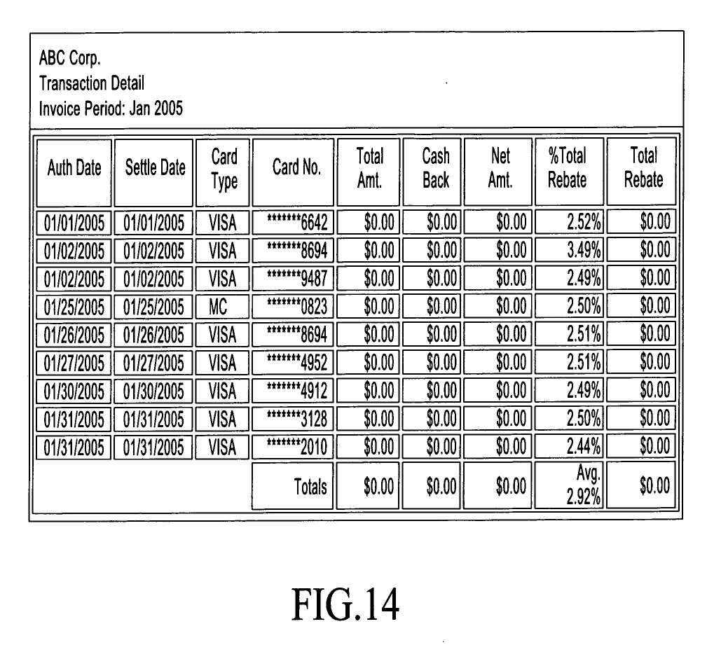

The reports of an embodiment include numerous Merchant Reports as described above. The Merchant Reports of an embodiment include a Merchant Invoice Monthly Invoice (Merchant Settlement Invoice), Merchant Invoice by Store, Merchant Invoice Summary Report, Merchant Invoice by Supporter Report, Merchant Invoice by Group Contribution Report, and Merchant Invoice Transaction Detail Report to name a few. FIGS. 5 and 6 each show an example of Merchant Invoice Monthly Invoices (Merchant Settlement Invoice), under an embodiment. FIG. 7 is an example of a Merchant Invoice by Store, under an embodiment. FIG. 8 is an example of a Merchant Invoice Summary Report, under an embodiment. FIGS. 9 and 10 each show an example of Merchant Invoice by Supporter Reports, in CSV and PDF file formats respectively, under an embodiment. FIGS. 11 and 12 each show an example of Merchant Invoice by Group Contribution Reports, in CSV and PDF file formats respectively, under an embodiment. FIGS. 13 and 14 each show an example of Merchant Invoice Transaction Detail Reports, in CSV and PDF file formats respectively, under an embodiment.

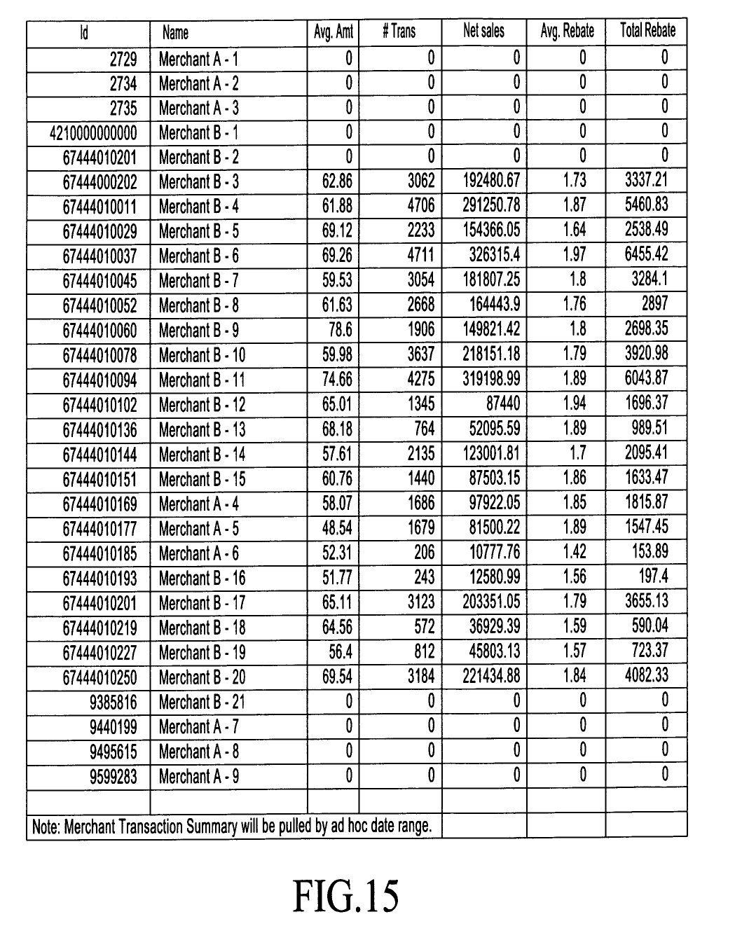

FIG. 15 is an example of a Merchant Transaction Summary Report, under an embodiment. The Merchant Transaction Summary Report is generated or created on an ad-hoc, real-time basis to report sales and transaction volume by merchant for any date range specified. The end-user or requester submits the merchant and date range parameters. The database of the ACS provider in response reports back the sales, transaction volume, and rebate for the specified period. The data may be reported back at the corporate level, chain level, and/or down to the individual store level. This report is critical to allow merchant partners and ACS provider staff to review sales activity for date ranges outside of the normal calendar month invoice periods. For example, a merchant may want to see sales for the previous five (5) days or a summary total for the past six (6) months. Merchants may view the data for their account only. Staff may view individual merchants or all merchants simultaneously. The Merchant Transaction Summary Report of this example is in the CSV file format but is not so limited.

The reports of an embodiment include Group ACH and Merchant ACH Reports as described above. The format of the Group and Merchant ACH reports is generally in an envelope structure comprising a File Header/Trailer, Batch Header/Trailer, and detailed transaction records. The File Header provides information about the company that prepared (originated) the file, when it was prepared, and the bank to which it is being transmitted for processing. The File Trailer provides record, block, amount and hash totals of the records contained in the file to verify the file's integrity. There is only one set of File Headers/Trailers in the file of an embodiment but the embodiment is not so limited.

The Batch Header of the Group ACH and Merchant ACH Reports provides information about the detail records which follow the header. This information includes one or more of Standard Entry Class (e.g. PPD, CCD etc.), Effective Date, and Description or “purpose” (e.g. generic ‘Payroll’, ‘Dues’, etc.). As long as the records contain the same three pieces of information, they can be batched together. The Batch Trailer provides record, amount and hash totals of the records contained in the batch. There is no limit as to the number of batches.

The detailed transaction records of the Group ACH and Merchant ACH Reports include the “basic” transaction information including one or more of Routing Number, Account Number, Amount, Individual ID Name (the account name that is maintained internally for the other party), Individual ID Number (the ID number that is maintained internally for the other party), and Transaction Code (identifies the transaction as a Debit or Credit, and the account type, such as checking, savings, etc.). Additional payment-related information can be entered in one of more addendum records (e.g. month represented by group deposit ACH).

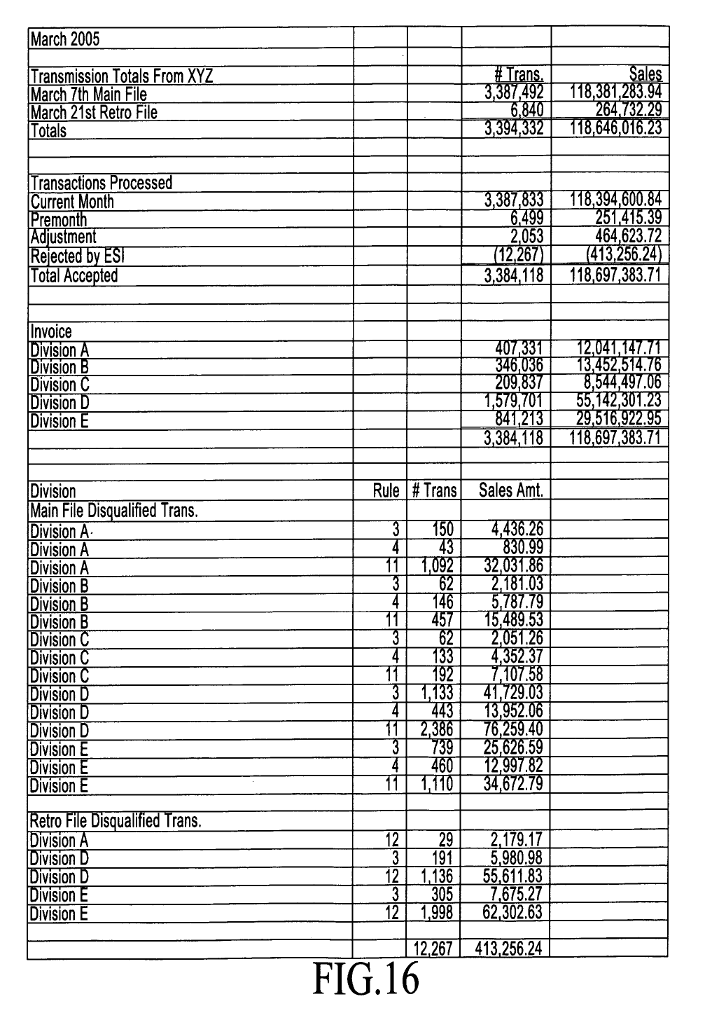

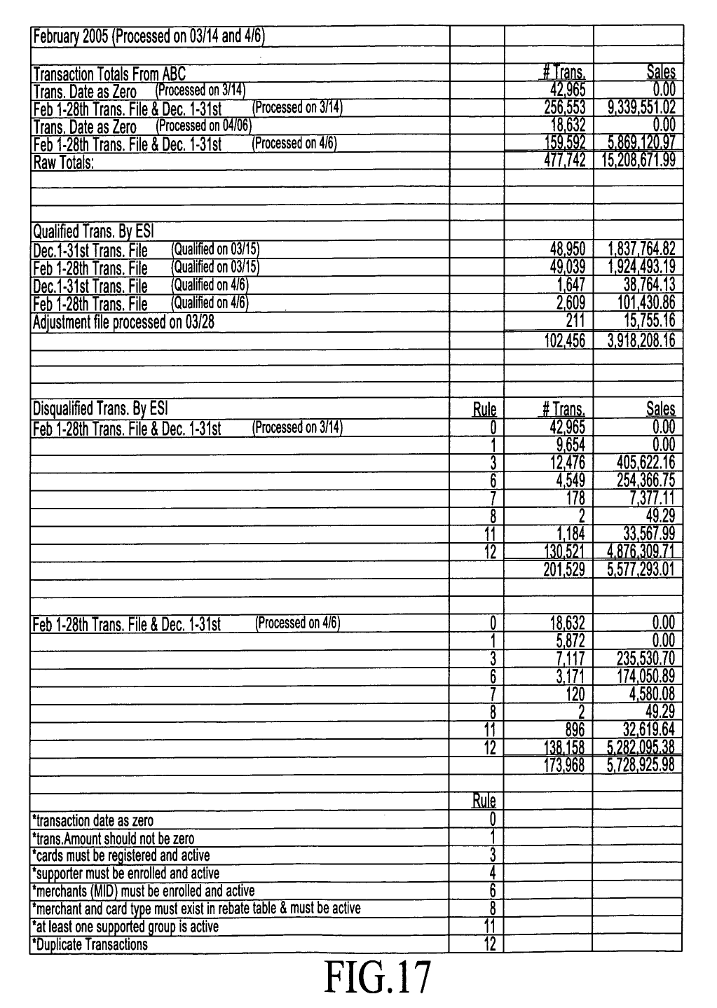

The reports of an embodiment include Merchant Reconciliation Reports as described above. FIGS. 16 and 17 are example Merchant Reconciliation Reports, under an embodiment.

The reports of an embodiment include Pre-enrolled and Fully-enrolled Group Reports as described above. The Pre-enrolled/Fully-enrolled Reports of an embodiment identify one or more of groups that are in pre-enrolled status along with the amount of contribution accrued, groups that switched from pre-enrolled to fully-enrolled during the specified month and the amount of funds released to them, and a summary of the total accruals and payments by month for all groups and the net effect on total pre-enrolled accrual.

The reports of an embodiment include Unusual Transaction Reports as described above. The Unusual Transaction Report is used to identify anomalies in the sales and transaction volumes for merchants registered in the ACS program. The ACS provider determines the parameters for each merchant in terms of expected volume and average individual transaction. Should actual sales/transaction volumes fall outside of these ranges (by a pre-determined percent), the activity is reported on Unusual Transaction Reports for follow-up/research. The Unusual Transaction Reports is produced monthly, for example, and is generally approved by management prior to the generation of merchant invoices.

The reports of an embodiment include Cap Analysis Reports as described above. In order to comply with the marketing requirement to limit financial exposure of participating merchants in the ACS, the ACS of an embodiment provides to the merchants reports of one or more of Cap by Period (Monthly or Annually) and Cap by Group (Monthly or Annually).

In the case of Cap by Period, the ACS allows for an analysis process to be run after the completion of the Volume rebate calculation. This analysis establishes whether the cap has been breached and, if the cap has been breached, runs a secondary process to reduce the Base rebates, the Volume rebates and the fee by a calculated factor to keep the Total Invoice to the Merchant below the agreed cap.

In the case of Cap by Group, the ACS identifies any Groups with a Contribution that exceeds the designated cap. In this case a reduction process is then run against all transactions allocate to the Group, reducing the Base rebates, the Volume rebates and the fee by a calculated factor to ensure the Group cap was not exceeded.

The reports of an embodiment include Group Statements as described above. The Group Statements include Group Statement Summary Reports, Group Statement by Merchant Reports, Group Statement by Supporter Reports, and Pre-summarized data for My Assistant, but are not so limited. Group Statements of an embodiment allow web-based viewing by group coordinators and support personnel, but are not so limited. The reports are formatted in HTML with an optional CSV download. The backend system of the ACP provider provides a data service that accepts calls across the internet from the front-end web application server and in response returns structured data to the calling server via a secure channel; the data is formatted and returned to the user as HTML and CSV encoded files, but is not so limited.

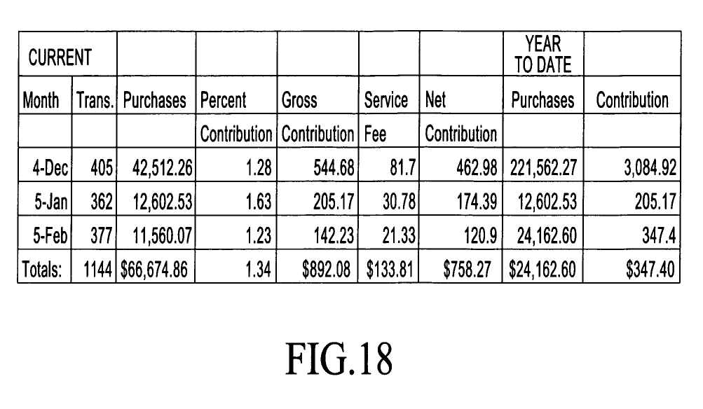

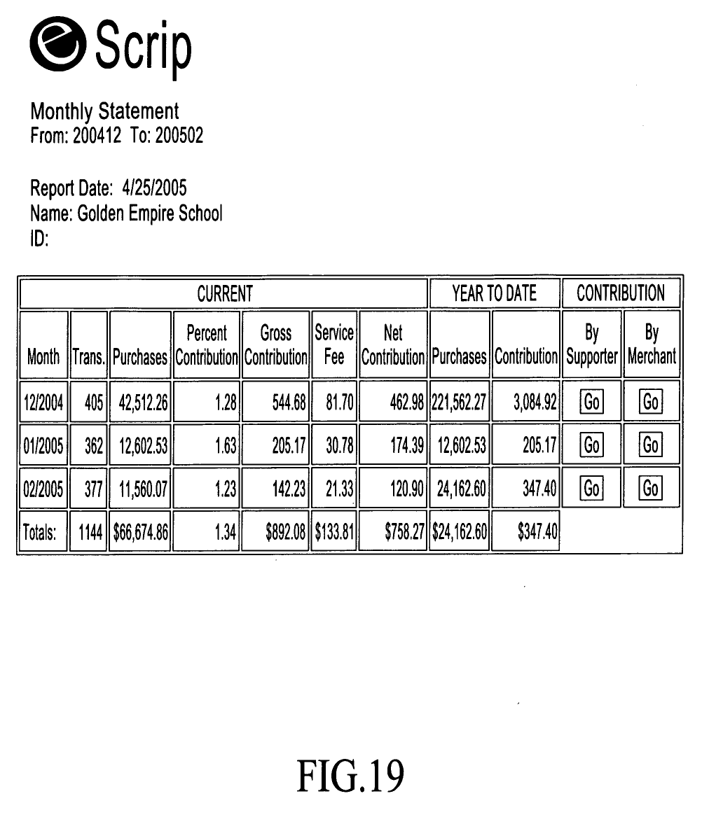

FIGS. 18 and 19 each show an example Group Statement Summary Report, in CSV and PDF file formats respectively, under an embodiment. This report highlights the fields of most interest from previous group statements. The user has the option to pull the report by start and end dates ranging in the last 24 months from the current statement month. Each row in the summary table represents a statement month. The summary table also serves as an interface for the user to select Group Statement by Merchant or Group Statement by Supporter on a monthly basis.

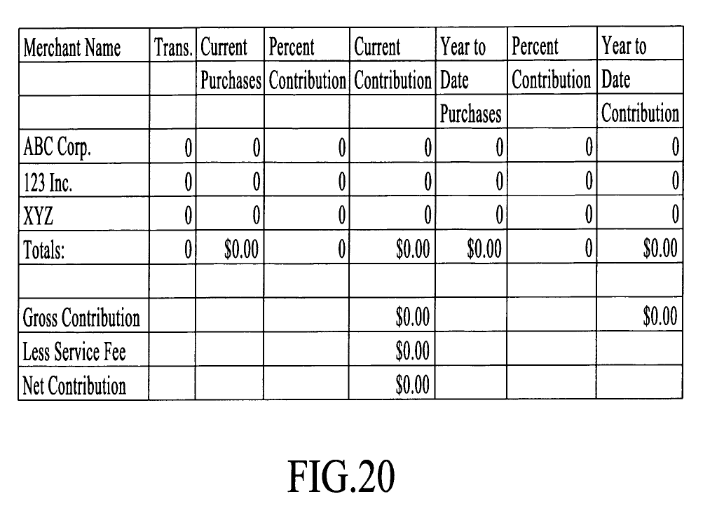

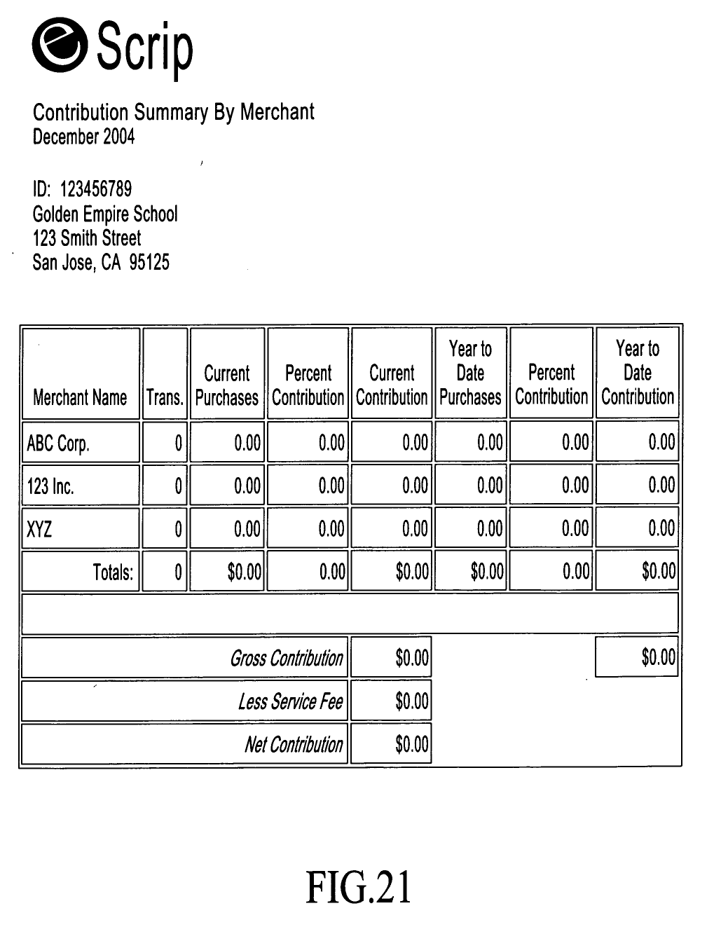

FIGS. 20 and 21 each show an example Group Statement by Merchant Report, in CSV and PDF file formats respectively, under an embodiment. This report includes all qualified purchase transactions made by supporters of the group in a monthly period. The purchase transactions are aggregated and displayed by merchant. In addition to the aggregated merchant data, the report displays calculated fields including Gross Contribution, Service Fee and Net Contribution.

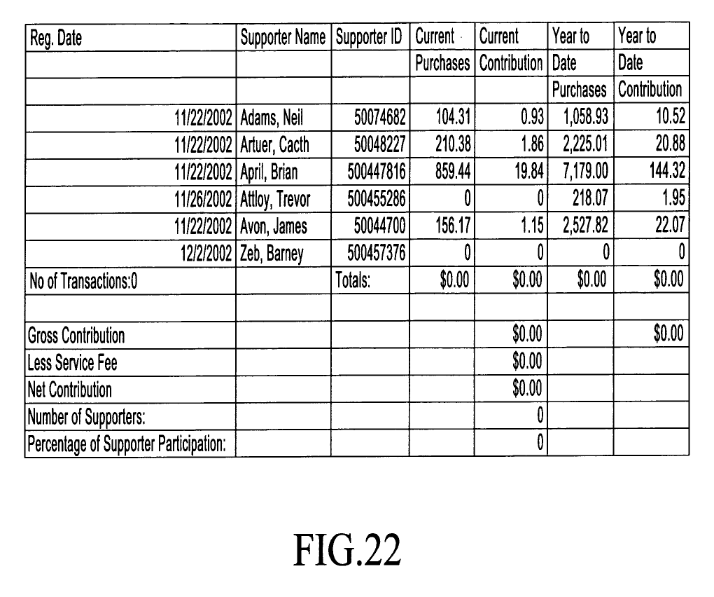

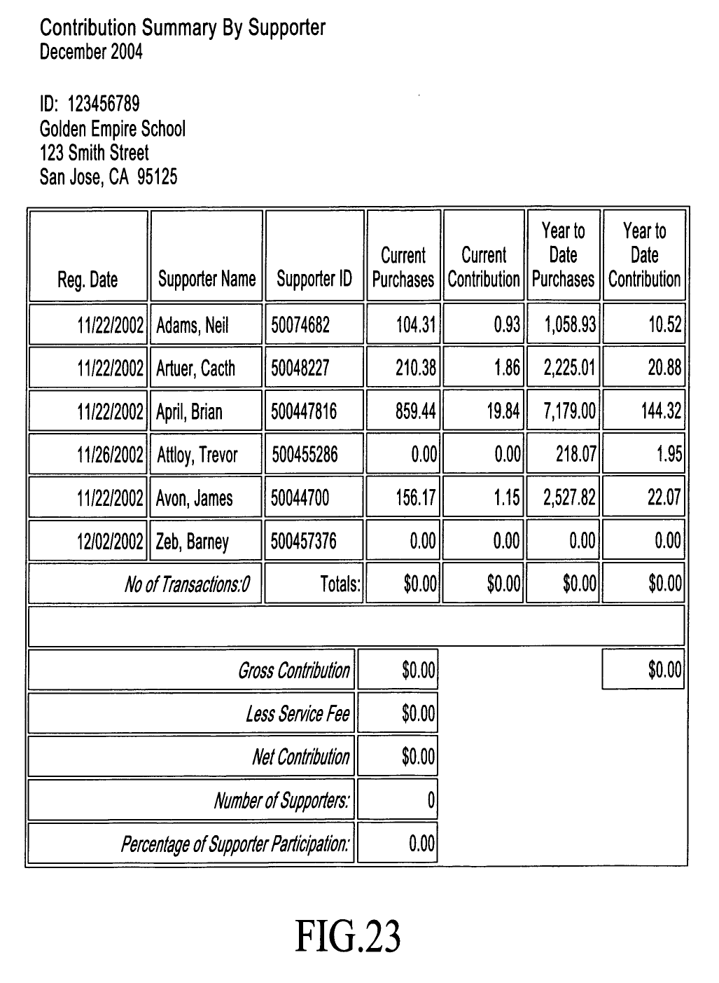

FIGS. 22 and 23 each show an example Group Statement by Supporter Report, in CSV and PDF file formats respectively, under an embodiment. This report includes all qualified purchase transactions made by supporters of the group in a monthly period. The purchase transactions are aggregated and displayed by supporter. In addition to the aggregated supporter data, the report displays calculated fields including Gross Contribution, Service Fee, Net Contribution, Number of Supporters, and Percentage of Supporter Participation.

The Pre-summarized data for My Assistant Report facilitates supporter queries in “My Assistant.” My Assistant is a web application used by group coordinators to channel market to supporters. The report includes a Supporter ID field and a Purchase Activity field. The Supporter ID field is populated with all actively registered supporters at the time the report is generated. The Purchase Activity field is a Boolean field set to zero for all supporters who did not make a purchase with a participating merchant in the two (2) months preceding the report's run date. The report is run monthly, immediately after completing a statement cycle but is not so limited. Access to this data may be provided in realtime through the system interface and/or may be provided monthly as a data dump in a structured file for import into the supporter master file in the web database.

The reports of an embodiment include Supporter Statements as described above. Supporter Statements are viewed by ACS supporters and support personnel. An embodiment includes three (3) discrete channels by which statement data are displayed, channels which include the web, electronic mail, and postal marketing campaigns.

For Supporter Statement data displayed via the web, a data service is used in an embodiment that accepts calls across the internet from the front-end system web application server and return structured data to the calling server in a secure channel where the data will be formatted and returned to the user as an HTML file. The Supporter Statement report includes information of qualified purchase transactions made by supporters in a monthly period. The Supporter Statement report includes content divisions for Supporter, Supported Groups, Transaction Table, and Grocery Section to name a few. The Supporter division displays supporter demographics to include supporter ID, name and address.

The Supported Group section of the Supporter Statement enumerates the groups selected by the supporter as beneficiary of the supporter's rebate. The supporter will have a minimum of one group and a maximum of three groups. This table displays the group name, the “split” which is a pro rata distribution of contribution across the groups, and “Donation Year to Date” which is an accrual of all contributions paid to the group(s) from the ACS as a result of the supporter's purchases.

The Transaction Table of the Supporter Statement provides an enumeration of all qualified supporter purchase transactions for the month sorted by merchant. Merchant Name, Date, Card Type and Purchase Amount resolve from raw transactional data. Contribution Percent, Current Amount and Year-to-Date Amounts are calculated by way of the ACS Month End Process.

The Grocery Section of the Supporter Statement displays a summary of purchase transactions made by the supporter with his/her lead merchant, for example lead grocer. Lead grocers are established by marketing on a geographic basis. Each supporter is assigned a marketing channel and this value is stored on the supporter master file. During statement production, the supporter's channel attribute is compared with a lead grocery file and when appropriate (not all channels have a lead grocer), the Grocery Section is populated. When merchants have more than one identity at the parent, chain, sub-chain or store level, the merchant identity with domicile in the supporter's channel is presented first and then followed by all peers at that level in the merchant hierarchy. In addition to the recapitulation of purchases, the Grocery Section displays a year to date donation figure for all supporters of each supported group (1-3) from the domicile lead grocer.

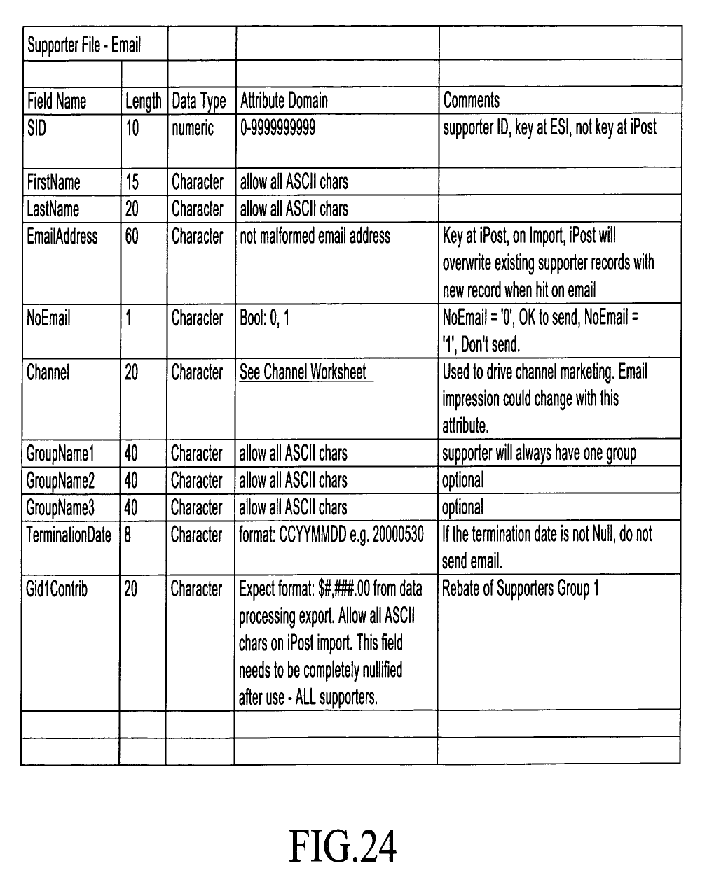

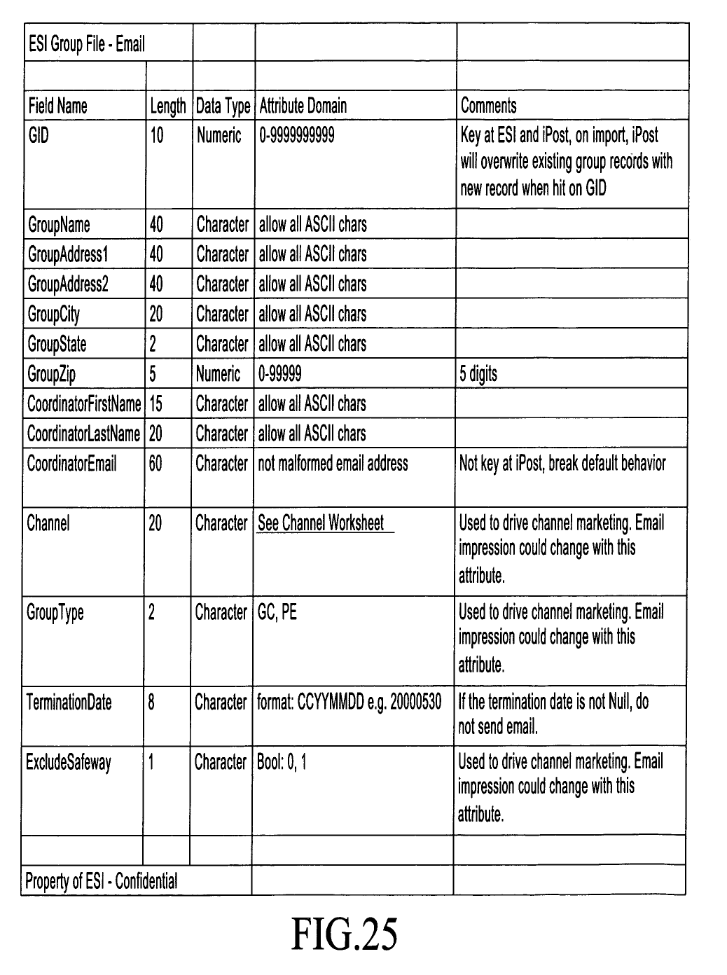

As an example of statement data displayed via email, FIG. 24 is a Supporter File email, under an embodiment. As another example of statement data displayed via email, FIG. 25 is an ESI Group File email, under an embodiment. Supporter demographics and statement data are output from the ACS backend system for use in marketing email campaigns. The period used for these reports, nominally a year, can be any period for which data is available.

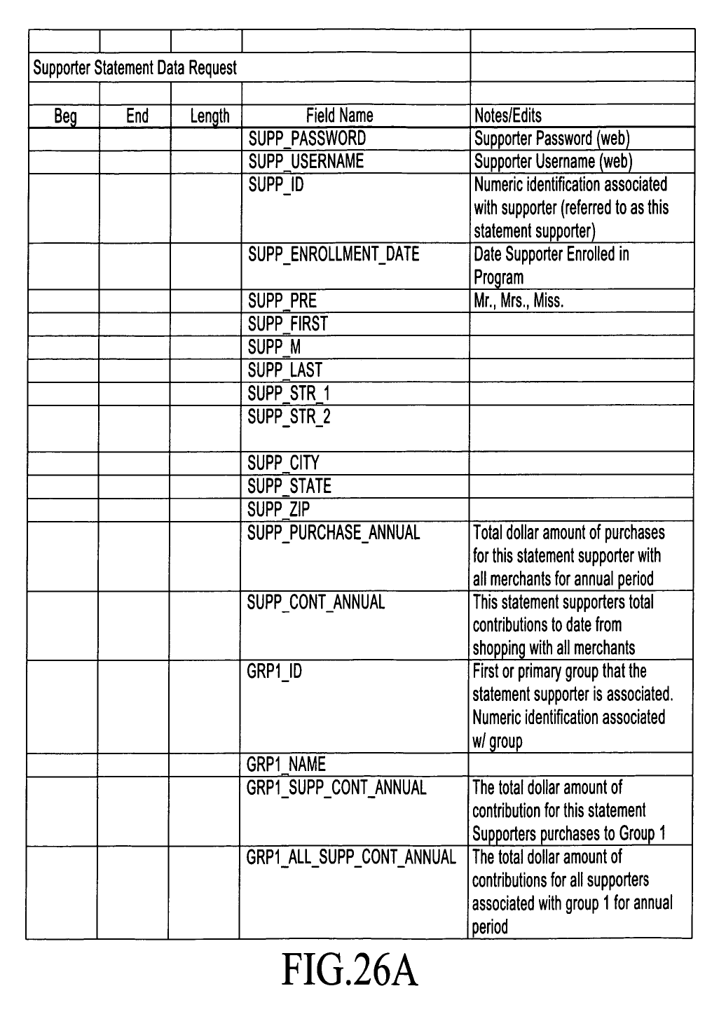

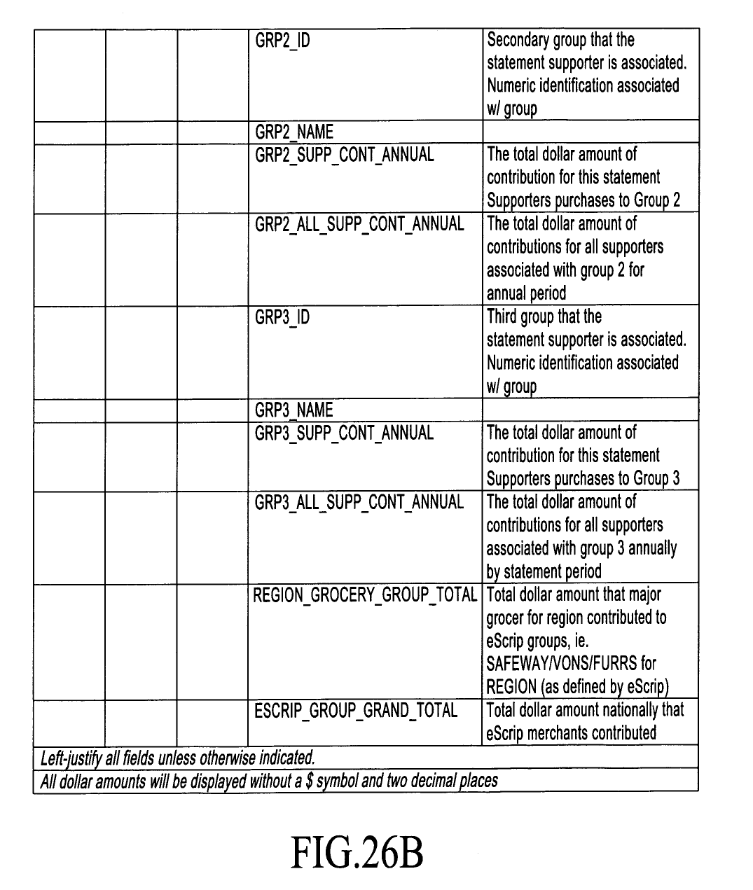

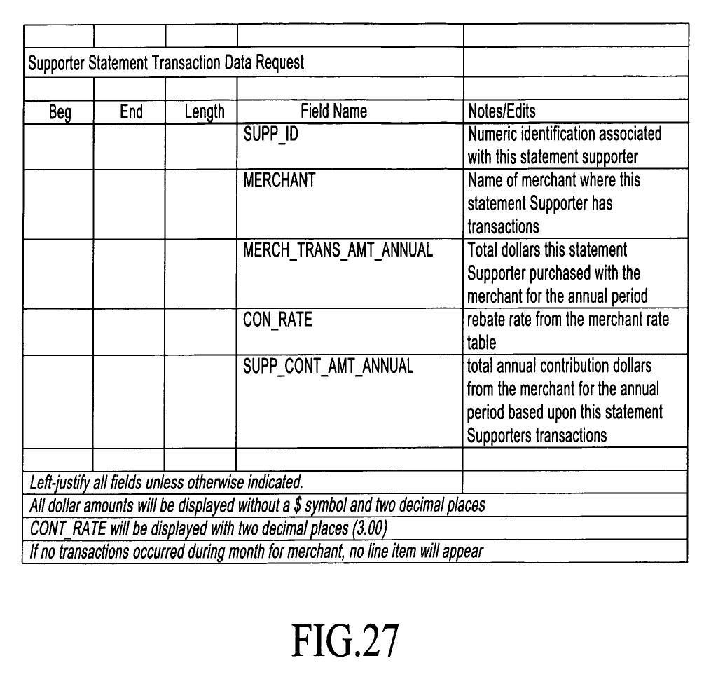

For statement data displayed via postal marketing campaigns, supporter demographics and statement data is output from the backend for use in marketing postal campaigns. The period used for these reports, nominally a year, can be any period or months for which data is available. FIGS. 26A and 26B is an example Supporter Statement Data Request, under an embodiment. FIG. 27 is an example Supporter Statement Transaction Data Request, under an embodiment.

The ACS of an embodiment periodically generates or creates a series of XML instance files. The series of XML instance files are for example created monthly representing supporter and group statements. The files are consumed by outsource vendors who provide marketing analysis, email and postal campaigns. Additionally, XML statement files can be used to fulfill real-time calls for statements from the web across the ACS system interface. The supporter and group statements are produced and archived monthly for the indefinite future.

The XML instance files of an embodiment conform to ACS rules sets as described herein. Additionally, the instance files are validated by the producer by holding them against validating XSD schemas of the ACS. The XML files created periodically (e.g. monthly) include one or more of a Supporter Statement, Supporter Index, Supporter Error Log, Group Statement by Supporter, Group Statement by Merchant, Group Index, Group Error Log, and Card Transaction File, to name a few.

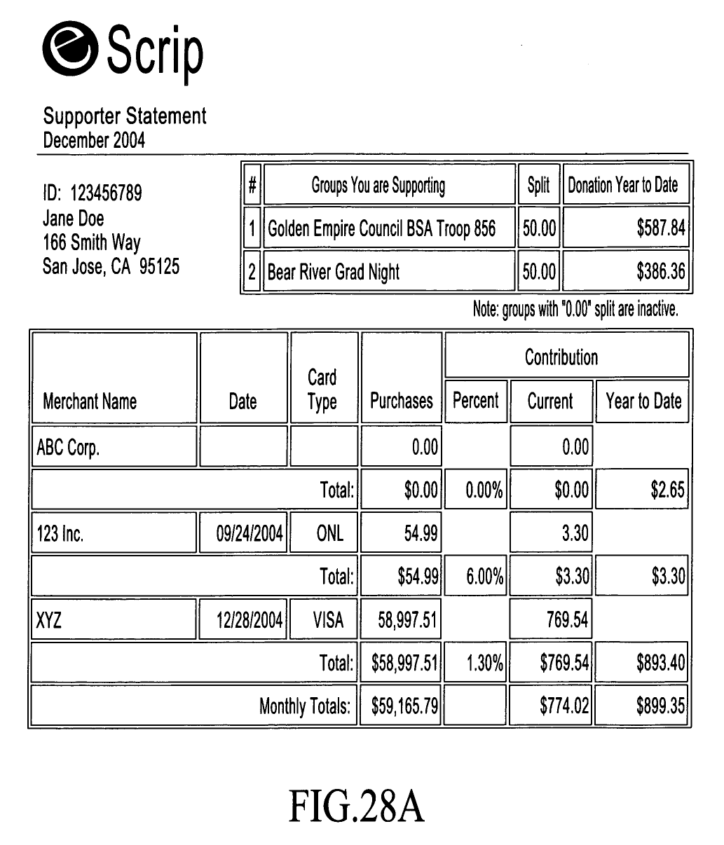

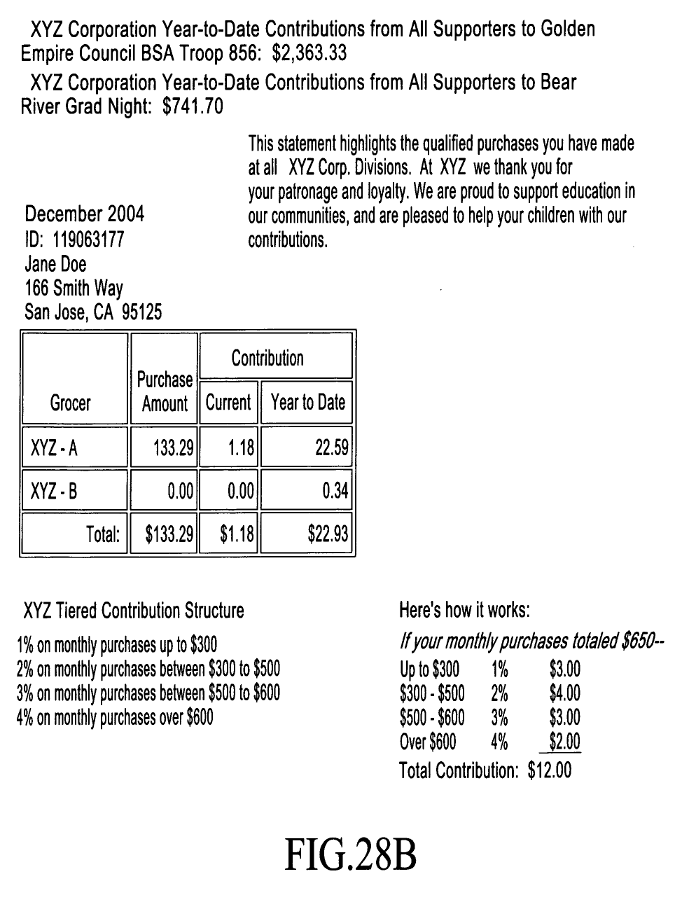

FIGS. 28A and 28B is an example Supporter Statement, under an embodiment. The ACS of an embodiment generates one supporter statement per supporter month, but is not so limited.

The XML instance files of an embodiment include Supporter Index files as described above. The Supporter Index file includes one index including all active supporters having a statement monthly. The Supporter Index file includes fields of interest from each supporter statement and is used by the statement producer to establish statement process control. Supporter Index file is provided to downstream consumers of the instance files to select individual instance files without having to process the contents of all statements.

The XML instance files of an embodiment include a Supporter Error Log file as described above. The Supporter Error Log file includes a record of supporter statement instance files which were rejected by the producer (backend vendor) when validated by the ACS XML Schema Definition (XSD) validating schemas. Additionally, producers may append records to the Supporter Error Log file which passed validation on the XSD schemas but were problematic otherwise. Entries in this error log represent statements that are to be corrected. The producer clears all errors in the log which can be attributed to programming or systematic errors, then reproduce statements for those supporters. Entries in the Supporter Error Log file with malformed supporter demographics are forwarded for appropriate correction of the supporter records. When complete, these supporter statements are reprocessed. In addition to the above, downstream consumers produce error logs in this format to establish currency between the backend vendor and themselves. Taken together, the supporter index and error log represent the status of supporter statements for a statement month.

The XML instance files of an embodiment include a Group Statement by Supporter file and a Group Statement by Merchant file as described above. The XML instance files of an embodiment also include a Group Index file, which is one index including all active groups having a statement monthly. The Group Index file includes fields of interest from each group statement. The Group Index file is used by the statement producer to establish statement process control. The Group Index file is provided to downstream consumers of the instance files to select individual instance files without having to process the contents of all statements.

The XML instance files of an embodiment include a Group Error Log file. The Group Error Log file includes a record of all group statement instance files which were rejected by the producer (backend vendor) when validated by the ACS XSD validating schemas. Additionally, producers may append records to this file which passed validation on the XSD schemas but were problematic otherwise. Entries in the Group Error Log file represent statements that need to be corrected. The producer will clear all errors in the log which can be attributed to programming or systematic errors, then reproduce statements for those groups. Entries in the Group Error Log file with malformed group demographics are forwarded for correction of the group records. When complete, these group statements are reprocessed. In addition to the above, downstream consumers produce error logs in this format to establish currency between the backend vendor and themselves. Taken together, the group index and error log represent the status of group statements for a statement month.

The XML instance files of an embodiment include a Card Transaction File. The Card Transaction File includes information of the card type and card number for each qualified purchase transaction represented in supporter statements. The entries in the Card Transaction File are limited to a subset of card types accepted in the program. For the most part the included card types are credit cards. The Card Transaction File is used for marketing analytics. The card information is populated into the Card Transaction File instead of the supporter statement instance file for security (supporter statements are passed to consumers who may email and/or print statements). The attribute “CardTransGUID” is common between supporter statement instance files and the card transaction file and is used to relate the independent records but is not so limited.

The ACS of an embodiment includes a method comprising receiving transaction data of a transaction between a merchant and a supporter. The transaction of an embodiment is a purchase transaction including use of a card and the transaction data is electronic data of the transaction. The ACS of an embodiment automatically debits the merchant by a rebate amount for the transaction. The ACS of an embodiment automatically credits a first portion of the rebate amount to an organization. The ACS of an embodiment automatically credits a second portion of the rebate amount to a scrip distributor.

The method of an embodiment distributes one or more of the first portion of the rebate amount to the organization and the second portion of the rebate amount to the scrip distributor.

The method of an embodiment registers the organization with the scrip distributor.

The method of an embodiment registers the card of the supporter with the scrip distributor. The registering of an embodiment comprises designating the organization as a beneficiary of the first portion of the rebate amount. The registering of an embodiment comprises designating one or more additional organizations as beneficiaries of the first portion of the rebate amount.

The card of an embodiment includes one or more of a credit card, a charge card, a debit card, a bank card, a prepaid card, a smart card, an automatic teller machine (“ATM”) card, a gift card, and a loyalty card.

The method of an embodiment registers one or more additional cards of the supporter with the scrip distributor.

The transaction of an embodiment is a qualifying transaction. A qualifying transaction of an embodiment is one that includes a purchase at a registered merchant made using a registered card. The registered merchant and the registered card of an embodiment are registered with the scrip distributor.

Receiving transaction data of an embodiment comprises receiving transaction data from one or more of the merchant and a third-party data warehouse of the merchant.

Receiving transaction data of an embodiment comprises receiving transaction data at one or more intervals of time.

The transaction data of an embodiment includes one or more of a transaction amount, a merchant identification, card identification, the rebate amount, a date, a time, and a location of the transaction.

One or more of the automatic debiting of an account of the merchant, automatic crediting of the first portion, and automatic crediting of the second portion of an embodiment is performed using the Automated Clearing House (ACH) system.

The method of an embodiment maintains a database with information of one or more of the merchant, the supporter, and the organization.

The method of an embodiment determines the second portion based on a percentage of total funds raised for the organization. The total funds are a sum of the first portion for a plurality of purchase transactions for which the organization is designated as a beneficiary of the first portion of the rebate amount.

The method of an embodiment performs account balancing among the rebate amount, the first portion, and the second portion, wherein the account balancing is performed at one or more intervals of time.

The method of an embodiment determines the rebate amount, wherein the rebate amount is separately determined for each merchant of a plurality of merchants.

The rebate amount of an embodiment is approximately equal to a percentage of a transaction amount of the transaction.

The percentage of an embodiment is a sum of a first percentage and a second percentage. The first percentage of the transaction amount of an embodiment approximately equals the first portion. The second percentage of the transaction amount of an embodiment approximately equals the second portion.

The second portion of an embodiment is a percentage of the rebate amount.

The rebate amount of an embodiment includes a volume rebate awarded to the supporter as a result of spending at the merchant that exceeds a pre-specified threshold.

The method of an embodiment generates a plurality of reports and provides access to the plurality of reports to one or more of the merchant, the supporter, and the organization. Each of the plurality of reports of an embodiment includes one or more of merchant data, supporter data, organization data, the transaction data, and rebate data.

The ACS of an embodiment includes a system comprising at least one electronic transaction system coupled to a processor. The electronic transaction system of an embodiment is configured to receive transaction data of the transaction. The transaction of an embodiment is a purchase transaction including use of a card and the transaction data is electronic data of the transaction. The electronic transaction system of an embodiment is configured to automatically debit the merchant by a rebate amount for the transaction. The electronic transaction system of an embodiment is configured to automatically credit a first portion of the rebate amount to an organization. The electronic transaction system of an embodiment is configured to automatically credit a second portion of the rebate amount to a scrip distributor.

The electronic transaction system of an embodiment is configured to control distribution of one or more of the first portion of the rebate amount to the organization and the second portion of the rebate amount to the scrip distributor.

The electronic transaction system of an embodiment is configured to one or more of register the organization with the scrip distributor and register the card of the supporter with the scrip distributor.

The card of an embodiment includes one or more of a credit card, a charge card, a debit card, a bank card, a prepaid card, a smart card, an automatic teller machine (“ATM”) card, a gift card, and a loyalty card.

The transaction of an embodiment is a qualifying transaction, wherein a qualifying transaction is one that includes a purchase at a registered merchant made using a registered card, wherein the registered merchant and the registered card are registered with the scrip distributor.

The transaction data of an embodiment includes one or more of a transaction amount, a merchant identification, card identification, the rebate amount, a date, a time, and a location of the transaction.

One or more of the automatic debiting of an account of the merchant, automatic crediting of the first portion, and automatic crediting of the second portion of an embodiment is performed using the Automated Clearing House (ACH) system.

The electronic transaction system of an embodiment is configured to determine the second portion based on a percentage of total funds raised for the organization. The total funds of an embodiment are a sum of the first portion for a plurality of purchase transactions for which the organization is designated as a beneficiary of the first portion of the rebate amount.

The electronic transaction system of an embodiment is configured to determine the rebate amount, wherein the rebate amount is separately determined for each merchant of a plurality of merchants.

The rebate amount of an embodiment is approximately equal to a percentage of a transaction amount of the transaction. The percentage of an embodiment is a sum of a first percentage and a second percentage. The first percentage of the transaction amount of an embodiment equals the first portion. The second percentage of the transaction amount of an embodiment equals the second portion.

The second portion of an embodiment is a percentage of the rebate amount.

The electronic transaction system of an embodiment is configured to generate a plurality of reports. Each of the plurality of reports of an embodiment include one or more of merchant data, supporter data, organization data, the transaction data, and rebate data. The electronic transaction system of an embodiment is configured to provide access to the plurality of reports to one or more of the merchant, the supporter, and the organization.

The ACS of an embodiment includes computer readable medium including executable instructions which, when executed in a processing system, perform a transaction between a merchant and a supporter. The transaction performed by the instructions of the computer readable medium of an embodiment includes receiving transaction data of the transaction. The transaction of an embodiment is a purchase transaction including use of a card and the transaction data is electronic data of the transaction. The transaction performed by the instructions of the computer readable medium of an embodiment includes automatically debiting the merchant by a rebate amount for the transaction. The transaction performed by the instructions of the computer readable medium of an embodiment includes automatically crediting a first portion of the rebate amount to an organization. The transaction performed by the instructions of the computer readable medium of an embodiment includes automatically crediting a second portion of the rebate amount to a scrip distributor.

The transaction performed by the instructions of the computer readable medium of an embodiment includes distributing one or more of the first portion of the rebate amount to the organization and the second portion of the rebate amount to the scrip distributor.

The transaction performed by the instructions of the computer readable medium of an embodiment includes one or more of registering the organization with the scrip distributor and registering the card of the supporter with the scrip distributor.

The card of an embodiment includes one or more of a credit card, a charge card, a debit card, a bank card, a prepaid card, a smart card, an automatic teller machine (“ATM”) card, a gift card, and a loyalty card.

The transaction performed by the instructions of the computer readable medium of an embodiment includes a qualifying transaction. A qualifying transaction of an embodiment is one that includes a purchase at a registered merchant made using a registered card. The registered merchant and the registered card of an embodiment are registered with the scrip distributor.

Receiving transaction data of an embodiment comprises receiving transaction data at one or more intervals of time.

The transaction data of an embodiment includes one or more of a transaction amount, a merchant identification, card identification information, the rebate amount, a date, a time, and a location of the transaction.

One or more of the automatic debiting of an account of the merchant, automatic crediting of the first portion, and automatic crediting of the second portion of an embodiment is performed using the Automated Clearing House (ACH) system.

The transaction performed by the instructions of the computer readable medium of an embodiment includes determining the second portion based on a percentage of total funds raised for the organization. The total funds of an embodiment are a sum of the first portion for a plurality of purchase transactions for which the organization is designated as a beneficiary of the first portion of the rebate amount.

The transaction performed by the instructions of the computer readable medium of an embodiment includes determining the rebate amount. The rebate amount of an embodiment is separately determined for each merchant of a plurality of merchants.

The rebate amount of an embodiment is approximately equal to a percentage of a transaction amount of the transaction. The percentage of an embodiment is a sum of a first percentage and a second percentage. The first percentage of the transaction amount of an embodiment equals the first portion. The second percentage of the transaction amount of an embodiment equals the second portion.

The second portion of an embodiment is a percentage of the rebate amount.

The transaction performed by the instructions of the computer readable medium of an embodiment includes generating a plurality of reports. Each of the plurality of reports of an embodiment include one or more of merchant data, supporter data, organization data, the transaction data, and rebate data. The transaction performed by the instructions of the computer readable medium of an embodiment includes providing access to the plurality of reports to one or more of the merchant, the supporter, and the organization.

Aspects of the ACS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the ACS include: microcontrollers with memory (such as electronically erasable programmable read-only memory (EEPROM)), embedded microprocessors, firmware, software, etc. Furthermore, aspects of the ACS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the various systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the ACS is not intended to be exhaustive or to limit the systems and methods for fabricating ICs to the precise form disclosed. While specific embodiments of, and examples for, the ACS are described herein for illustrative purposes, various equivalent modifications are possible within the scope of other systems and methods for fabricating ICs, as those skilled in the relevant art will recognize. The teachings of the ACS provided herein can be applied to other processing systems and methods, not only for the systems and methods for fabricating ICs described above.

The elements and acts of the various embodiments described above can be combined to provide further embodiments. These and other changes can be made to the ACS in light of the above detailed description.

In general, in the following claims, the terms used should not be construed to limit the ACS to the specific embodiments disclosed in the specification and the claims, but should be construed to include all processing systems that operate under the claims. Accordingly, the ACS is not limited by the disclosure, but instead the scope of the ACS is to be determined entirely by the claims.

While certain aspects of the ACS are presented below in certain claim forms, the inventors contemplate the various aspects of the ACS in any number of claim forms. Accordingly, the inventors reserve the right to add additional claims after filing the application to pursue such additional claim forms for other aspects of the ACS.

What is claimed is:

1. A method comprising:
receiving transaction data of a transaction between a merchant and a supporter, wherein the transaction is a purchase transaction including use of a card and the transaction data is electronic data of the transaction;
automatically debiting the merchant by a rebate amount for the transaction;
automatically crediting a first portion of the rebate amount to an organization; and
automatically crediting a second portion of the rebate amount to a scrip distributor.

2. The method of claim 1, further comprising distributing one or more of the first portion of the rebate amount to the organization and the second portion of the rebate amount to the scrip distributor.

3. The method of claim 1, comprising registering the organization with the scrip distributor.

4. The method of claim 1, comprising registering the card of the supporter with the scrip distributor.

5. The method of claim 4, wherein the registering comprises designating the organization as a beneficiary of the first portion of the rebate amount.

6. The method of claim 4, wherein the registering comprises designating one or more additional organizations as beneficiaries of the first portion of the rebate amount.

7. The method of claim 1, wherein the card includes one or more of a credit card, a charge card, a debit card, a bank card, a prepaid card, a smart card, an automatic teller machine (“ATM”) card, a gift card, and a loyalty card.

8. The method of claim 1, comprising registering one or more additional cards of the supporter with the scrip distributor.

9. The method of claim 1, wherein the transaction is a qualifying transaction, wherein a qualifying transaction is one that includes a purchase at a registered merchant made using a registered card, wherein the registered merchant and the registered card are registered with the scrip distributor.

10. The method of claim 1, wherein receiving transaction data comprises receiving transaction data from one or more of the merchant and a third-party data warehouse of the merchant.

11. The method of claim 1, wherein receiving transaction data comprises receiving transaction data at one or more intervals of time.

12. The method of claim 1, wherein the transaction data includes one or more of a transaction amount, a merchant identification, a card identification, the rebate amount, a date, a time, and a location of the transaction.

13. The method of claim 1, wherein one or more of the automatic debiting of an account of the merchant, automatic crediting of the first portion, and automatic crediting of the second portion is performed using the Automated Clearing House (ACH) system.

14. The method of claim 1, further comprising maintaining a database with information of one or more of the merchant, the supporter, and the organization.

15. The method of claim 1, further comprising determining the second portion based on a percentage of total funds raised for the organization, wherein the total funds are a sum of the first portion for a plurality of purchase transactions for which the organization is designated as a beneficiary of the first portion of the rebate amount.

16. The method of claim 1, comprising performing account balancing among the rebate amount, the first portion, and the second portion, wherein the account balancing is performed at one or more intervals of time.

17. The method of claim 1, further comprising determining the rebate amount, wherein the rebate amount is separately determined for each merchant of a plurality of merchants.

18. The method of claim 1, wherein the rebate amount is approximately equal to a percentage of a transaction amount of the transaction.

19. The method of claim 18, wherein the percentage is a sum of a first percentage and a second percentage, wherein the first percentage of the transaction amount equals the first portion, wherein the second percentage of the transaction amount equals the second portion.

20. The method of claim 1, wherein the second portion is a percentage of the rebate amount.

21. The method of claim 1, wherein the rebate amount includes a volume rebate awarded to the supporter as a result of spending at the merchant that exceeds a pre-specified threshold.

22. The method of claim 1, comprising:
generating a plurality of reports, wherein each of the plurality of reports include one or more of merchant data, supporter data, organization data, the transaction data, and rebate data; and
providing access to the plurality of reports to one or more of the merchant, the supporter, and the organization.

23. A system comprising at least one electronic transaction system coupled to a processor, the electronic transaction system configured to receive transaction data of the transaction, wherein the transaction is a purchase transaction including use of a card and the transaction data is electronic data of the transaction, the electronic transaction system configured to automatically debit the merchant by a rebate amount for the transaction, the electronic transaction system configured to automatically credit a first portion of the rebate amount to an organization, and the electronic transaction system configured to automatically credit a second portion of the rebate amount to a scrip distributor.

24. The system of claim 23, wherein the electronic transaction system is configured to control distribution of one or more of the first portion of the rebate amount to the organization and the second portion of the rebate amount to the scrip distributor.

25. The system of claim 23, wherein the electronic transaction system is configured to one or more of register the organization with the scrip distributor and register the card of the supporter with the scrip distributor.

26. The system of claim 23, wherein the card includes one or more of a credit card, a charge card, a debit card, a bank card, a prepaid card, a smart card, an automatic teller machine (“ATM”) card, a gift card, and a loyalty card.

27. The system of claim 23, wherein the transaction is a qualifying transaction, wherein a qualifying transaction is one that includes a purchase at a registered merchant made using a registered card, wherein the registered merchant and the registered card are registered with the scrip distributor.

28. The system of claim 23, wherein the transaction data includes one or more of a transaction amount, a merchant identification, a card identification, the rebate amount, a date, a time, and a location of the transaction.

29. The system of claim 23, wherein one or more of the automatic debiting of an account of the merchant, automatic crediting of the first portion, and automatic crediting of the second portion is performed using the Automated Clearing House (ACH) system.

30. The system of claim 23, wherein the electronic transaction system is configured to determine the second portion based on a percentage of total funds raised for the organization, wherein the total funds are a sum of the first portion for a plurality of purchase transactions for which the organization is designated as a beneficiary of the first portion of the rebate amount.

31. The system of claim 23, wherein the electronic transaction system is configured to determine the rebate amount, wherein the rebate amount is separately determined for each merchant of a plurality of merchants.

32. The system of claim 23, wherein the rebate amount is approximately equal to a percentage of a transaction amount of the transaction.

33. The system of claim 32, wherein the percentage is a sum of a first percentage and a second percentage, wherein the first percentage of the transaction amount equals the first portion, wherein the second percentage of the transaction amount equals the second portion.

34. The system of claim 23, wherein the second portion is a percentage of the rebate amount.

35. The system of claim 23, wherein the electronic transaction system is configured to generate a plurality of reports, wherein each of the plurality of reports include one or more of merchant data, supporter data, organization data, the transaction data, and rebate data, wherein the electronic transaction system is configured to provide access to the plurality of reports to one or more of the merchant, the supporter, and the organization.

36. Computer readable medium including executable instructions which, when executed in a processing system, perform a transaction between a merchant and a supporter, the transaction comprising:
receiving transaction data of the transaction, wherein the transaction is a purchase transaction including use of a card and the transaction data is electronic data of the transaction;
automatically debiting the merchant by a rebate amount for the transaction;
automatically crediting a first portion of the rebate amount to an organization; and
automatically crediting a second portion of the rebate amount to a scrip distributor.

37. The medium of claim 36, the transaction comprising distributing one or more of the first portion of the rebate amount to the organization and the second portion of the rebate amount to the scrip distributor.

38. The medium of claim 36, the transaction comprising one or more of registering the organization with the scrip distributor and registering the card of the supporter with the scrip distributor.

39. The medium of claim 36, wherein the card includes one or more of a credit card, a charge card, a debit card, a bank card, a prepaid card, a smart card, an automatic teller machine (“ATM”) card, a gift card, and a loyalty card.

40. The medium of claim 36, wherein the transaction is a qualifying transaction, wherein a qualifying transaction is one that includes a purchase at a registered merchant made using a registered card, wherein the registered merchant and the registered card are registered with the scrip distributor.

41. The medium of claim 36, wherein receiving transaction data comprises receiving transaction data at one or more intervals of time.

42. The medium of claim 36, wherein the transaction data includes one or more of a transaction amount, a merchant identification, a card identification, the rebate amount, a date, a time, and a location of the transaction.

43. The medium of claim 36, wherein one or more of the automatic debiting of an account of the merchant, automatic crediting of the first portion, and automatic crediting of the second portion is performed using the Automated Clearing House (ACH) system.

44. The medium of claim 36, the transaction comprising determining the second portion based on a percentage of total funds raised for the organization, wherein the total funds are a sum of the first portion for a plurality of purchase transactions for which the organization is designated as a beneficiary of the first portion of the rebate amount.

45. The medium of claim 36, the transaction comprising determining the rebate amount, wherein the rebate amount is separately determined for each merchant of a plurality of merchants.

46. The medium of claim 36, wherein the rebate amount is approximately equal to a percentage of a transaction amount of the transaction.

47. The medium of claim 46, wherein the percentage is a sum of a first percentage and a second percentage, wherein the first percentage of the transaction amount equals the first portion, wherein the second percentage of the transaction amount equals the second portion.

48. The medium of claim 36, wherein the second portion is a percentage of the rebate amount.

49. The medium of claim 36, the transaction comprising:
generating a plurality of reports, wherein each of the plurality of reports include one or more of merchant data, supporter data, organization data, the transaction data, and rebate data; and
providing access to the plurality of reports to one or more of the merchant, the supporter, and the organization.
